(19) United States
(12) Patent Application Publication
(10) Pub. No.: US 2018/0058211 A1
(43) Pub. Date: Mar. 1, 2018

(54) JOINT INVERSION OF DOWNHOLE TOOL MEASUREMENTS

(71) Applicant: Schlumberger Technology Corporation, Sugar Land, TX (US)

(72) Inventors: Lin Liang, Belmont, MA (US); Aria Abubakar, Sugar Land, TX (US); Tarek M. Habashy, Burlington, MA (US)

(21) Appl. No.: 15/690,306

(22) Filed: Aug. 30, 2017

Related U.S. Application Data
(60) Provisional application No. 62/381,406, filed on Aug. 30, 2016.

(51) Int. Cl. E21B 49/00; E21B 44/00; G01V 1/28

(52) U.S. Cl. CPC E21B 49/00; G01V 2200/16; G01V 1/282; E21B 44/00

(57) ABSTRACT

A method includes acquiring measurement values from at least two different types of downhole tools disposed in a portion of a bore in a formation; selecting formation parameters for joint inversion; building a near-bore fluid flow model of at least a portion of the formation that includes at least the portion of the bore; simulating fluid flow based at least in part on the near-bore fluid flow model and the selected formation parameters to generate simulated measurement values; comparing the acquired measurement values and the simulated measurement values; based at least in part on the comparing, revising at least one of the selected formation parameters to generate revised formation parameters and simulating fluid flow based at least in part on the near-bore fluid flow model and the revised formation parameters to generate revised simulated measurement values; and outputting at least the revised formation parameters to characterize the formation.

### RELATED APPLICATION

This application claims priority to and the benefit of a U.S. Provisional Application having Ser. No. 62/381,406, filed 30 Aug. 2016, which is incorporated by reference herein.

### BACKGROUND

Interpretation is a process that involves analysis of data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.).

### SUMMARY

A method can include acquiring measurement values from at least two different types of downhole tools disposed in a portion of a bore in a formation; selecting formation parameters for joint inversion; building a near-bore fluid flow model of at least a portion of the formation that includes at least the portion of the bore; simulating fluid flow based at least in part on the near-bore fluid flow model and the selected formation parameters to generate simulated measurement values; comparing the acquired measurement values and the simulated measurement values; based at least in part on the comparing, revising at least one of the selected formation parameters to generate revised formation parameters and simulating fluid flow based at least in part on the near-bore fluid flow model and the revised formation parameters to generate revised simulated measurement values; and outputting at least the revised formation parameters where the revised formation parameters characterize the formation. A system can include a processor; memory operatively coupled to the processor; and processor-executable instructions stored in the memory to instruct the system to: acquire measurement values from at least two different types of downhole tools disposed in a portion of a bore in a formation; select formation parameters for joint inversion; build a near-bore fluid flow model of at least a portion of the formation that includes at least the portion of the bore; simulate fluid flow based at least in part on the near-bore fluid flow model and the selected formation parameters to generate simulated measurement values; compare the acquired measurement values and the simulated measurement values; based at least in part on the comparison, revise at least one of the selected formation parameters to generate revised formation parameters and simulating fluid flow based at least in part on the near-bore fluid flow model and the revised formation parameters to generate revised simulated measurement values; and output at least the revised formation parameters where the revised formation parameters characterize the formation. One or more computer-readable storage media can include computer-executable instructions executable to instruct a computing system to: acquire measurement values from at least two different types of downhole tools disposed in a portion of a bore in a formation; select formation parameters for joint inversion; build a near-bore fluid flow model of at least a portion of the formation that includes at least the portion of the bore; simulate fluid flow based at least in part on the near-bore fluid flow model and the selected formation parameters to generate simulated measurement values; compare the acquired measurement values and the simulated measurement values; based at least in part on the comparison, revise at least one of the selected formation parameters to generate revised formation parameters and simulating fluid flow based at least in part on the near-bore fluid flow model and the revised formation parameters to generate revised simulated measurement values; and output at least the revised formation parameters where the revised formation parameters characterize the formation. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a sedimentary basin, an example of a method, an example of a formation, an example of a borehole, an example of a borehole tool, an example of a convention and an example of a system;

FIG. 3 illustrates an example of a technique that may acquire data;

FIG. 4 illustrates examples of equipment including examples of downhole tools and examples of bores;

FIG. 5 illustrates examples of equipment including examples of downhole tools;

FIG. 6 illustrates an example of forward modeling and inversion as to seismic data and an Earth model of acoustic impedance;

FIG. 7 illustrates an example of a framework;

FIG. 8 illustrates an example of a method that includes forward modeling;

FIG. 9 illustrates an example of a method that includes joint inverting;

FIG. 10 illustrates an example of a method;

FIG. 11 illustrates an example of a method; and

FIG. 12 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

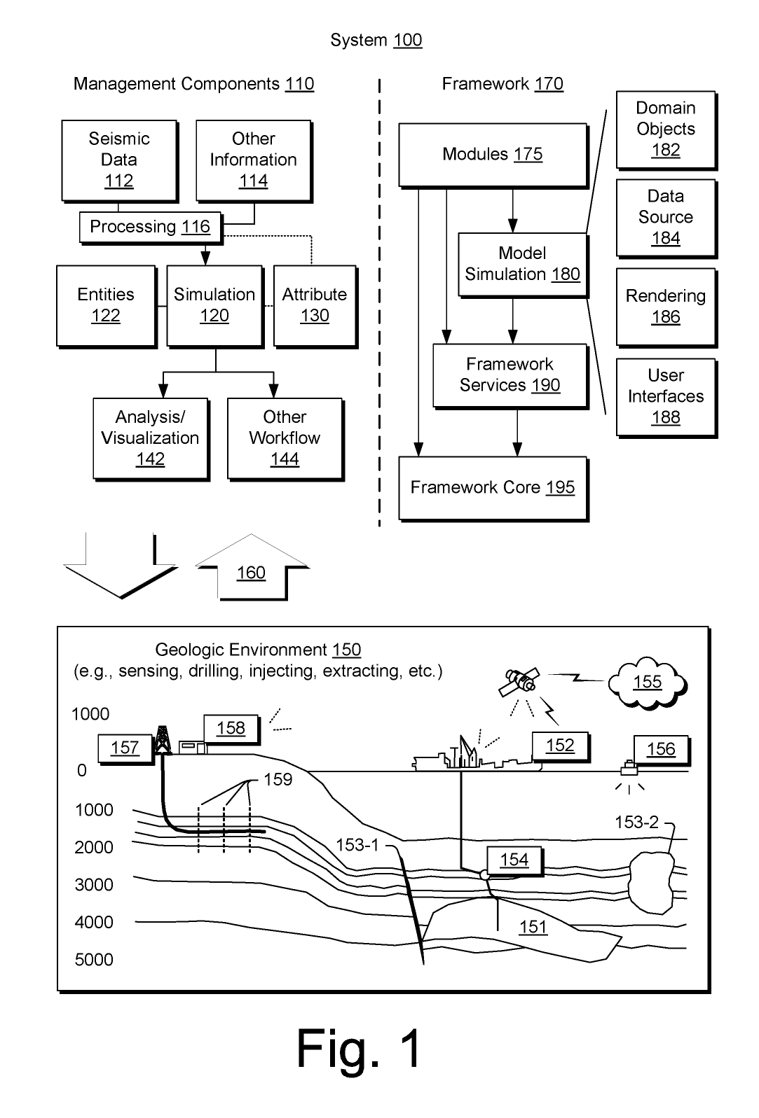

FIG. 1 shows an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, seismic data may be processed using a framework such as the OMEGA® framework (Schlumberger Limited, Houston, Tex.). The OMEGA® framework provides features that can be implemented for processing of seismic data, for example, through prestack seismic interpretation and seismic inversion. A framework may be scalable such that it enables processing and imaging on a single workstation, on a massive compute cluster, etc. As an example, one or more techniques, technologies, etc. described herein may optionally be implemented in conjunction with a framework such as, for example, the OMEGA® framework.

A framework for processing data may include features for 2D line and 3D seismic surveys. Modules for processing seismic data may include features for prestack seismic interpretation (PSI), optionally pluggable into a framework such as the OCEAN® framework. A workflow may be specified to include processing via one or more frameworks, plug-ins, add-ons, etc. A workflow may include quantitative interpretation, which may include performing pre- and poststack seismic data conditioning, inversion (e.g., seismic to properties and properties to synthetic seismic), wedge modeling for thin-bed analysis, amplitude versus offset (AVO) and amplitude versus angle (AVA) analysis, reconnaissance, etc. As an example, a workflow may aim to output rock properties based at least in part on processing of seismic data. As an example, various types of data may be processed to provide one or more models (e.g., earth models). For example, consider processing of one or more of seismic data, well data, electromagnetic and magnetic telluric data, reservoir data, etc.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

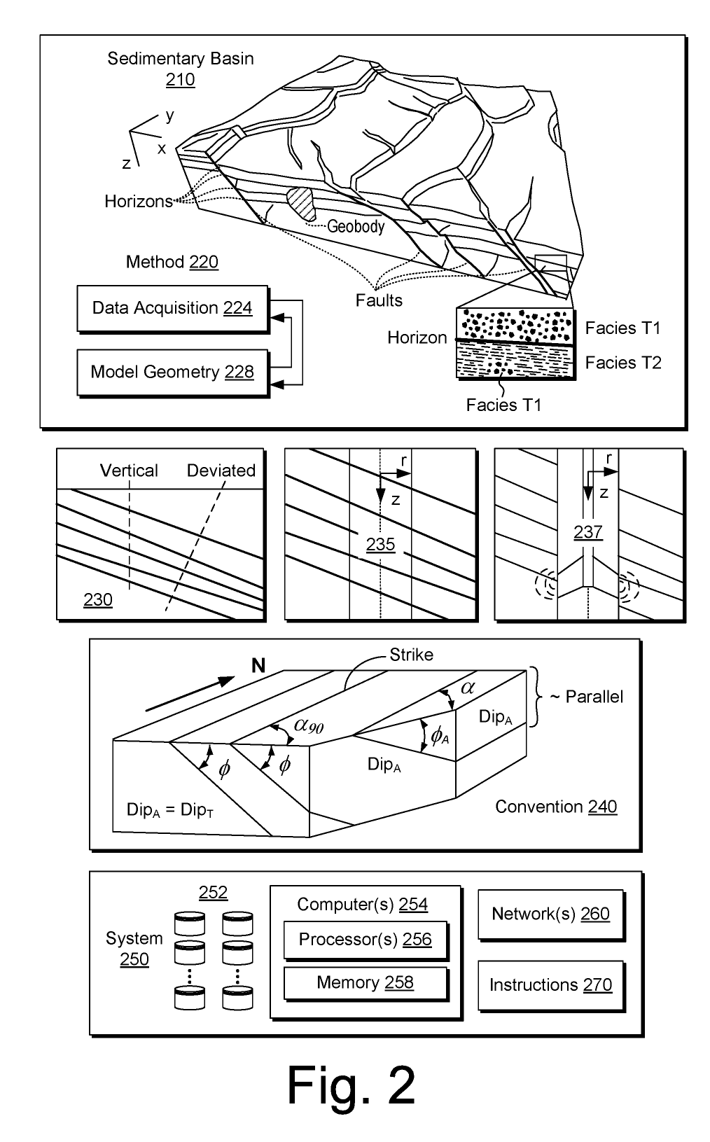

FIG. 2 shows an example of a sedimentary basin 210 (e.g., a geologic environment), an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Tex.) includes features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool may be configured to acquire electrical borehole images. As an example, the fullbore Formation Microlmager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole may be vertical, deviate and/or horizontal. As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG® framework (Schlumberger Limited, Houston, Tex.).

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles φ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As an example, equations may be provided for petroleum expulsion and migration, which may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient.

As shown in FIG. 2, the system 250 includes one or more information storage devices 252, one or more computers 254, one or more networks 260 and one or more sets of instructions 270. As to the one or more computers 254, each computer may include one or more processors (e.g., or processing cores) 256 and memory 258 for storing instructions (e.g., one or more of the one or more sets of instructions 270), for example, executable by at least one of the one or more processors 256. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more sets of instructions 270 may include instructions (e.g., stored in the memory 258) executable by one or more processors of the one or more processors 256 to instruct the system 250 to perform various actions. As an example, the system 250 may be configured such that the one or more sets of instructions 270 provide for establishing the framework 170 of FIG. 1 or a portion thereof. As an example, one or more methods, techniques, etc. may be performed using one or more sets of instructions, which may be, for example, one or more of the one or more sets of instructions 270 of FIG. 2.

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than about 1 Hz and/or optionally more than about 100 Hz). Seismic data may be processed and interpreted, for example, to understand better composition, fluid content, extent and geometry of subsurface rocks.

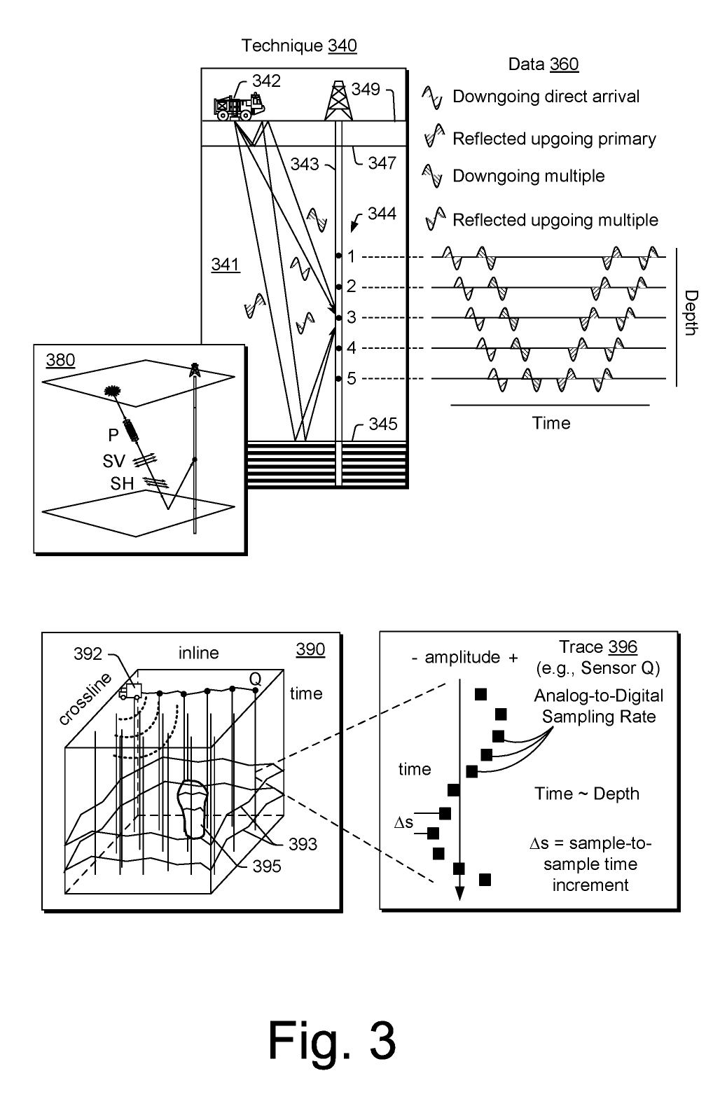

FIG. 3 shows an example of an acquisition technique 340 to acquire seismic data (see, e.g., data 360). As an example, a system may process data acquired by the technique 340, for example, to allow for direct or indirect management of sensing, drilling, injecting, extracting, etc., with respect to a geologic environment. In turn, further information about the geologic environment may become available as feedback (e.g., optionally as input to the system). As an example, an operation may pertain to a reservoir that exists in a geologic environment such as, for example, a reservoir. As an example, a technique may provide information (e.g., as an output) that may specifies one or more location coordinates of a feature in a geologic environment, one or more characteristics of a feature in a geologic environment, etc.

In FIG. 3, the technique 340 may be implemented with respect to a geologic environment 341. As shown, an energy source (e.g., a transmitter) 342 may emit energy where the energy travels as waves that interact with the geologic environment 341. As an example, the geologic environment 341 may include a bore 343 where one or more sensors (e.g., receivers) 344 may be positioned in the bore 343. As an example, energy emitted by the energy source 342 may interact with a layer (e.g., a structure, an interface, etc.) 345 in the geologic environment 341 such that a portion of the energy is reflected, which may then be sensed by one or more of the sensors 344. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 341 is shown as including a layer 347 that resides below a surface layer 349. Given such an environment and arrangement of the source 342 and the one or more sensors 344, energy may be sensed as being associated with particular types of waves.

As an example, a “multiple” may refer to multiply reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 3, the acquired data 360 can include data associated with downgoing direct arrival waves, reflected upgoing primary waves, downgoing multiple reflected waves and reflected upgoing multiple reflected waves. The acquired data 360 is also shown along a time axis and a depth axis. As indicated, in a manner dependent at least in part on characteristics of media in the geologic environment 341, waves travel at velocities over distances such that relationships may exist between time and space. Thus, time information, as associated with sensed energy, may allow for understanding spatial relations of layers, interfaces, structures, etc. in a geologic environment.

FIG. 3 also shows a diagram 380 that illustrates various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example of parameters that can characterize anisotropy of media (e.g., seismic anisotropy), consider the Thomsen parameters ε, δ and γ. The Thomsen parameter δ can describe offset effects (e.g., short offset). As to the Thomsen parameter E, it can describe offset effects (e.g., a long offset) and can relate to a difference between vertical and horizontal compressional waves (e.g., P or P-wave or quasi compressional wave qP or qP-wave). As to the Thomsen parameter γ, it can describe a shear wave effect. For example, consider an effect as to a horizontal shear wave with horizontal polarization to a vertical shear wave.

As an example, an inversion technique may be applied to generate a model that may include one or more parameters such as one or more of the Thomsen parameters. For example, one or more types of data may be received and used in solving an inverse problem that outputs a model (e.g., a reflectivity model, an impedance model, a fluid flow model, etc.).

In the example of FIG. 3, a diagram 390 shows acquisition equipment 392 emitting energy from a source (e.g., a transmitter) and receiving reflected energy via one or more sensors (e.g., receivers) strung along an inline direction. As the region includes layers 393 and, for example, the geobody 395, energy emitted by a transmitter of the acquisition equipment 392 can reflect off the layers 393 and the geobody 395. Evidence of such reflections may be found in the acquired traces. As to the portion of a trace 396, energy received may be discretized by an analog-to-digital converter that operates at a sampling rate. For example, the acquisition equipment 392 may convert energy signals sensed by sensor Q to digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

A 4D seismic survey involves acquisition of 3D seismic data at different times over a particular area. Such an approach can allow for assessing changes in a producing hydrocarbon reservoir with respect to time. As an example, changes may be observed in one or more of fluid location and saturation, pressure and temperature. 4D seismic data can be considered to be a form of time-lapse seismic data.

As an example, a seismic survey and/or other data acquisition may be for onshore and/or offshore geologic environments. As to offshore, streamers, seabed cables, nodes and/or other equipment may be utilized. As an example, nodes can be utilized as an alternative and/or in addition to seabed cables, which have been installed in several fields to acquire 4D seismic data. Nodes can be deployed to acquire seismic data (e.g., 4D seismic data) and can be retrievable after acquisition of the seismic data. As an example, a 4D seismic survey may call for one or more processes aimed at repeatability of data. A 4D survey can include two phases: a baseline survey phase and a monitor survey phase.

As an example, seismic data may be processed in a technique called “depth imaging” to form an image (e.g., a depth image) of reflection amplitudes in a depth domain for a particular target structure (e.g., a geologic subsurface region of interest).

As an example, seismic data may be processed to obtain an elastic model pertaining to elastic properties of a geologic subsurface region. For example, consider elastic properties such as density, compressional (P) impedance, compression velocity (vₚ)-to-shear velocity (vₛ) ratio, anisotropy, etc. As an example, an elastic model can provide various insights as to a surveyed region's lithology, reservoir quality, fluids, etc.

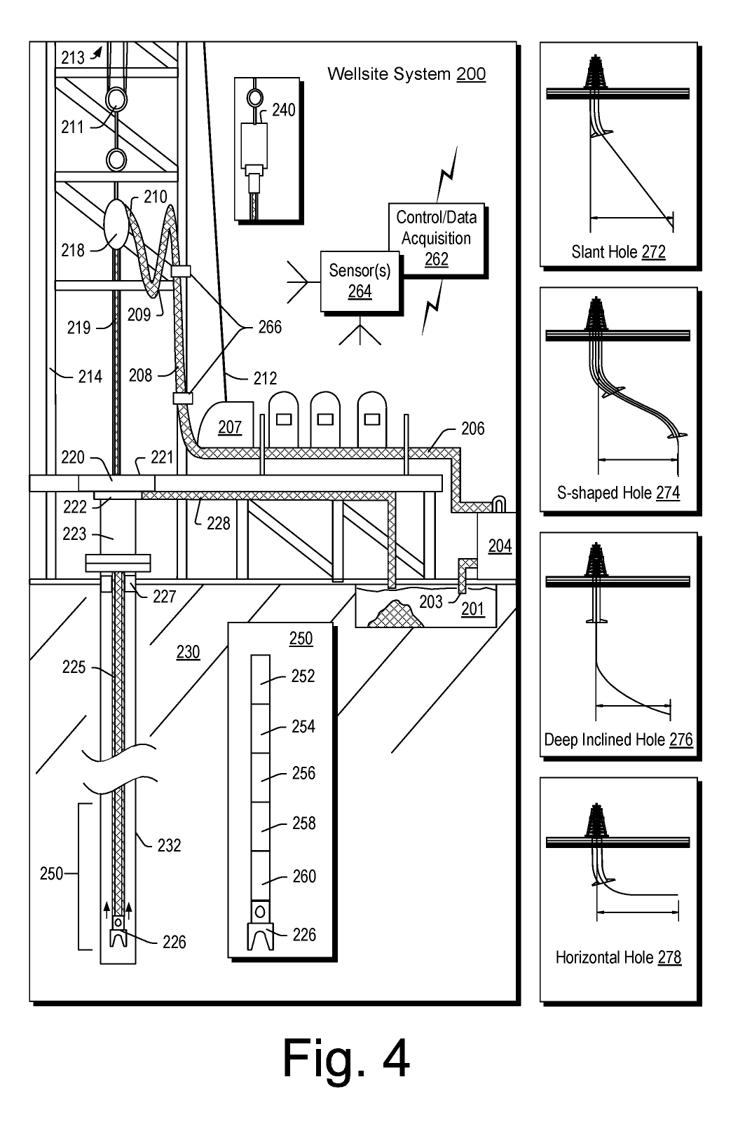

FIG. 4 shows an example of a wellsite system 400 (e.g., at a wellsite that may be onshore or offshore). As shown, the wellsite system 400 can include a mud tank 401 for holding mud and other material (e.g., where mud can be a drilling fluid), a suction line 403 that serves as an inlet to a mud pump 404 for pumping mud from the mud tank 401 such that mud flows to a vibrating hose 406, a drawworks 407 for winching drill line or drill lines 412, a standpipe 408 that receives mud from the vibrating hose 406, a kelly hose 409 that receives mud from the standpipe 408, a gooseneck or goosenecks 410, a traveling block 411, a crown block 413 for carrying the traveling block 411 via the drill line or drill lines 412, a derrick 414, a kelly 418 or a top drive 440, a kelly drive bushing 419, a rotary table 420, a drill floor 421, a bell nipple 422, one or more blowout preventors (BOPs) 423, a drillstring 425, a drill bit 426, a casing head 427 and a flow pipe 428 that carries mud and other material to, for example, the mud tank 401.

In the example system of FIG. 4, a borehole 432 is formed in subsurface formations 430 by rotary drilling; noting that various example embodiments may also use directional drilling.

As shown in the example of FIG. 4, the drillstring 425 is suspended within the borehole 432 and has a drillstring assembly 450 that includes the drill bit 426 at its lower end. As an example, the drillstring assembly 450 may be a bottom hole assembly (BHA).

The wellsite system 400 can provide for operation of the drillstring 425 and other operations. As shown, the wellsite system 400 includes the platform 411 and the derrick 414 positioned over the borehole 432. As mentioned, the wellsite system 400 can include the rotary table 420 where the drillstring 425 pass through an opening in the rotary table 420.

As shown in the example of FIG. 4, the wellsite system 400 can include the kelly 418 and associated components, etc., or a top drive 440 and associated components. As to a kelly example, the kelly 418 may be a square or hexagonal metal/alloy bar with a hole drilled therein that serves as a mud flow path. The kelly 418 can be used to transmit rotary motion from the rotary table 420 via the kelly drive bushing 419 to the drillstring 425, while allowing the drillstring 425 to be lowered or raised during rotation. The kelly 418 can pass through the kelly drive bushing 419, which can be driven by the rotary table 420. As an example, the rotary table 420 can include a master bushing that operatively couples to the kelly drive bushing 419 such that rotation of the rotary table 420 can turn the kelly drive bushing 419 and hence the kelly 418. The kelly drive bushing 419 can include an inside profile matching an outside profile (e.g., square, hexagonal, etc.) of the kelly 418; however, with slightly larger dimensions so that the kelly 418 can freely move up and down inside the kelly drive bushing 419.

As to a top drive example, the top drive 440 can provide functions performed by a kelly and a rotary table. The top drive 440 can turn the drillstring 425. As an example, the top drive 440 can include one or more motors (e.g., electric and/or hydraulic) connected with appropriate gearing to a short section of pipe called a quill, that in turn may be screwed into a saver sub or the drillstring 425 itself. The top drive 440 can be suspended from the traveling block 411, so the rotary mechanism is free to travel up and down the derrick 414. As an example, a top drive 440 may allow for drilling to be performed with more joint stands than a kelly/rotary table approach.

In the example of FIG. 4, the mud tank 401 can hold mud, which can be one or more types of drilling fluids. As an example, a wellbore may be drilled to produce fluid, inject fluid or both (e.g., hydrocarbons, minerals, water, etc.).

In the example of FIG. 4, the drillstring 425 (e.g., including one or more downhole tools) may be composed of a series of pipes threadably connected together to form a long tube with the drill bit 426 at the lower end thereof. As the drillstring 425 is advanced into a wellbore for drilling, at some point in time prior to or coincident with drilling, the mud may be pumped by the pump 404 from the mud tank 401 (e.g., or other source) via a the lines 406, 408 and 409 to a port of the kelly 418 or, for example, to a port of the top drive 440. The mud can then flow via a passage (e.g., or passages) in the drillstring 425 and out of ports located on the drill bit 426 (see, e.g., a directional arrow). As the mud exits the drillstring 425 via ports in the drill bit 426, it can then circulate upwardly through an annular region between an outer surface(s) of the drillstring 425 and surrounding wall(s) (e.g., open borehole, casing, etc.), as indicated by directional arrows. In such a manner, the mud lubricates the drill bit 426 and carries heat energy (e.g., frictional or other energy) and formation cuttings to the surface where the mud (e.g., and cuttings) may be returned to the mud tank 401, for example, for recirculation (e.g., with processing to remove cuttings, etc.).

The mud pumped by the pump 404 into the drillstring 425 may, after exiting the drillstring 425, form a mudcake that lines the wellbore which, among other functions, may reduce friction between the drillstring 425 and surrounding wall(s) (e.g., borehole, casing, etc.). A reduction in friction may facilitate advancing or retracting the drillstring 425. During a drilling operation, the entire drill string 425 may be pulled from a wellbore and optionally replaced, for example, with a new or sharpened drill bit, a smaller diameter drill string, etc. As mentioned, the act of pulling a drill string out of a hole or replacing it in a hole is referred to as tripping. A trip may be referred to as an upward trip or an outward trip or as a downward trip or an inward trip depending on trip direction.

As an example, consider a downward trip where upon arrival of the drill bit 426 of the drill string 425 at a bottom of a wellbore, pumping of the mud commences to lubricate the drill bit 426 for purposes of drilling to enlarge the wellbore. As mentioned, the mud can be pumped by the pump 404 into a passage of the drillstring 425 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 425) may be transmitted uphole to an uphole device, which may relay such information to other equipment for processing, control, etc.

As an example, telemetry equipment may operate via transmission of energy via the drillstring 425 itself. For example, consider a signal generator that imparts coded energy signals to the drillstring 425 and repeaters that may receive such energy and repeat it to further transmit the coded energy signals (e.g., information, etc.).

As an example, the drillstring 425 may be fitted with telemetry equipment 452 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 4, an uphole control and/or data acquisition system 462 may include circuitry to sense pressure pulses generated by telemetry equipment 452 and, for example, communicate sensed pressure pulses or information derived therefrom for process, control, etc.

The assembly 450 of the illustrated example includes a logging-while-drilling (LWD) module 454, a measuring-while-drilling (MWD) module 456, an optional module 458, a roto-steerable system and motor 460, and the drill bit 426.

The LWD module 454 may be housed in a suitable type of drill collar and can contain one or a plurality of selected types of logging tools. It will also be understood that more than one LWD and/or MWD module can be employed, for example, as represented at by the module 456 of the drillstring assembly 450. Where the position of an LWD module is mentioned, as an example, it may refer to a module at the position of the LWD module 454, the module 456, etc. An LWD module can include capabilities for measuring, processing, and storing information, as well as for communicating with the surface equipment. In the illustrated example, the LWD module 454 may include a seismic measuring device.

The MWD module 456 may be housed in a suitable type of drill collar and can contain one or more devices for measuring characteristics of the drillstring 425 and the drill bit 426. As an example, the MWD tool 454 may include equipment for generating electrical power, for example, to power various components of the drillstring 425. As an example, the MWD tool 454 may include the telemetry equipment 452, for example, where the turbine impeller can generate power by flow of the mud; it being understood that other power and/or battery systems may be employed for purposes of powering various components. As an example, the MWD module 456 may include one or more of the following types of measuring devices: a weight-on-bit measuring device, a torque measuring device, a vibration measuring device, a shock measuring device, a stick slip measuring device, a direction measuring device, and an inclination measuring device.

FIG. 4 also shows some examples of types of holes that may be drilled. For example, consider a slant hole 472, an S-shaped hole 474, a deep inclined hole 476 and a horizontal hole 478.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform method such as geosteering. As an example, a steerable system can include a PDM or of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 4, the wellsite system 400 can include one or more sensors 464 that are operatively coupled to the control and/or data acquisition system 462. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 400. As an example, a sensor or sensor may be at an offset wellsite where the wellsite system 400 and the offset wellsite are in a common field (e.g., oil and/or gas field).

As an example, one or more of the sensors 464 can be provided for tracking pipe, tracking movement of at least a portion of a drillstring, etc.

As an example, the system 400 can include one or more sensors 466 that can sense and/or transmit signals to a fluid conduit such as a drilling fluid conduit (e.g., a drilling mud conduit). For example, in the system 400, the one or more sensors 466 can be operatively coupled to portions of the standpipe 408 through which mud flows. As an example, a downhole tool can generate pulses that can travel through the mud and be sensed by one or more of the one or more sensors 466. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 400 can include a transmitter that can generate signals that can be transmitted downhole via mud (e.g., drilling fluid) as a transmission medium.

As an example, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, the can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings in the annulus.

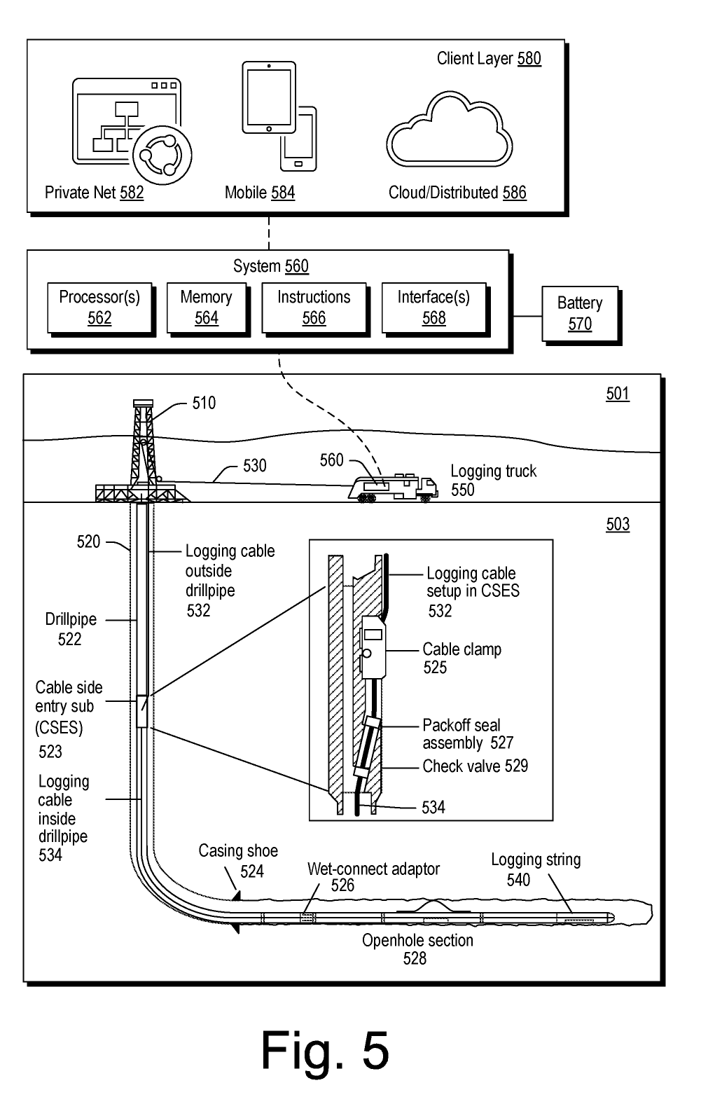

FIG. 5 shows an example of an environment 501 that includes a subterranean portion 503 where a rig 510 is positioned at a surface location above a bore 520. In the example of FIG. 5, various wirelines services equipment can be operated to perform one or more wirelines services including, for example, acquisition of data from one or more positions within the bore 520.

In the example of FIG. 5, the bore 520 includes drillpipe 522, a casing shoe, a cable side entry sub (CSES) 523, a wet-connector adaptor 526 and an openhole section 528. As an example, the bore 520 can be a vertical bore or a deviated bore where one or more portions of the bore may be vertical and one or more portions of the bore may be deviated, including substantially horizontal.

In the example of FIG. 5, the CSES 523 includes a cable clamp 525, a packoff seal assembly 527 and a check valve 529. These components can provide for insertion of a logging cable 530 that includes a portion 532 that runs outside the drillpipe 522 to be inserted into the drillpipe 522 such that at least a portion 534 of the logging cable runs inside the drillpipe 522. In the example of FIG. 5, the logging cable 530 runs past the wet-connect adaptor 526 and into the openhole section 528 to a logging string 540.

As shown in the example of FIG. 5, a logging truck 550 (e.g., a wirelines services vehicle) can deploy the wireline 530 under control of a system 560. As shown in the example of FIG. 5, the system 560 can include one or more processors 562, memory 564 operatively coupled to at least one of the one or more processors 562, instructions 566 that can be, for example, stored in the memory 564, and one or more interfaces 568. As an example, the system 560 can include one or more processor-readable media that include processor-executable instructions executable by at least one of the one or more processors 562 to cause the system 560 to control one or more aspects of equipment of the logging string 540 and/or the logging truck 550. In such an example, the memory 564 can be or include the one or more processor-readable media where the processor-executable instructions can be or include instructions. As an example, a processor-readable medium can be a computer-readable storage medium that is not a signal and that is not a carrier wave.

FIG. 5 also shows a battery 570 that may be operatively coupled to the system 560, for example, to power the system 560. As an example, the battery 570 may be a back-up battery that operates when another power supply is unavailable for powering the system 560 (e.g., via a generator of the wirelines truck 550, a separate generator, a power line, etc.). As an example, the battery 570 may be operatively coupled to a network, which may be a cloud network. As an example, the battery 570 can include smart battery circuitry and may be operatively coupled to one or more pieces of equipment via a SMBus or other type of bus.

As an example, the system 560 can be operatively coupled to a client layer 580. In the example of FIG. 5, the client layer 580 can include features that allow for access and interactions via one or more private networks 582, one or more mobile platforms and/or mobile networks 584 and via the “cloud” 586, which may be considered to include distributed equipment that forms a network such as a network of networks. As an example, the system 560 can include circuitry to establish a plurality of connections (e.g., sessions). As an example, connections may be via one or more types of networks. As an example, connections may be client-server types of connections where the system 560 operates as a server in a client-server architecture. For example, clients may log-in to the system 560 where multiple clients may be handled, optionally simultaneously.

FIGS. 1, 2, 3, 4 and 5 show various examples of equipment in various examples of environments. As an example, one or more workflows may be implemented to perform operations using equipment in one or more environments. As an example, a workflow may aim to understand an environment. As an example, a workflow may aim to drill into an environment, for example, to form a bore defined by surrounding earth (e.g., rock, fluids, etc.). As an example, a workflow may aim to acquire data from a downhole tool disposed in a bore where such data may be acquired via a drilling tool (e.g., as part of a bottom hole assembly) and/or a wireline tool. As an example, a workflow may aim to support a bore, for example, via casing. As an example, a workflow may aim to fracture an environment, for example, via injection of fluid. As an example, a workflow may aim to produce fluids from an environment via a bore. As an example, a workflow may utilize one or more frameworks that operate at least in part via a computer (e.g., a computing device, a computing system, etc.).

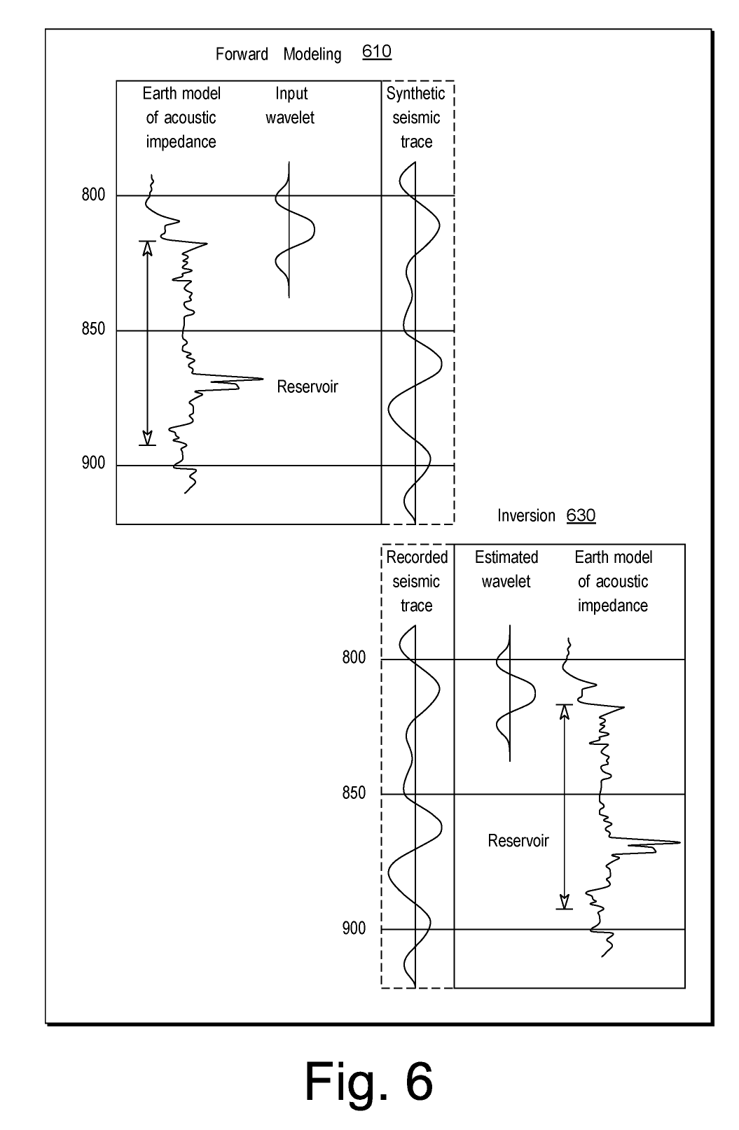

FIG. 6 shows an example of forward modeling 610 and an example of inversion 630 (e.g., an inversion or inverting). As shown, the forward modeling 610 progresses from an earth model of acoustic impedance and an input wavelet to a synthetic seismic trace while the inversion 630 progresses from a recorded seismic trace to an estimated wavelet and an earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

As an example, a method may employ amplitude inversion. For example, an amplitude inversion method may receive arrival times and amplitude of reflected seismic waves at a plurality of reflection points to solve for relative impedances of a formation bounded by the imaged reflectors. Such an approach may be a form of seismic inversion for reservoir characterization, which may assist in generation of models of rock properties.

As an example, an inversion process can commence with forward modeling, for example, to provide a model of layers with estimated formation depths, thicknesses, densities and velocities, which may, for example, be based at least in part on information such as well log information. A model may account for compressional wave velocities and density, which may be used to invert for P-wave, or acoustic, impedance. As an example, a model can account for shear velocities and, for example, solve for S-wave, or elastic, impedance. As an example, a model may be combined with a seismic wavelet (e.g., a pulse) to generate a synthetic seismic trace.

Inversion can aim to generate a “best-fit” model by, for example, iterating between forward modeling and inversion while seeking to minimize differences between a synthetic trace or traces and actual seismic data.

As an example, a framework such as the ISIS inversion framework (Schlumberger Limited, Houston Tex.) may be implemented to perform an inversion. As an example, a framework such as the Linearized Orthotropic Inversion framework (Schlumberger Limited, Houston, Tex.) may be implemented to perform an inversion.

As mentioned above, as to seismic data, forward modeling can include receiving an earth model of acoustic impedance and an input wavelet to a synthetic seismic trace while inverting can include progressing from a recorded seismic trace to an estimated wavelet and an earth model of acoustic impedance.

As an example, another approach to forward modeling and inversion can be for measurements acquired at least in part via a downhole tool where such measurements include different types of measurements, which may be referred to as multi-physics measurements. As an example, multi-physics measurements may include logging while drilling (LWD) measurements and/or wireline measurements. As an example, a method can include joint petrophysical inversion (e.g., inverting) for interpretation of multi-physics logging-while-drilling (LWD) measurements and/or wireline (WL) measurements.

As an example, a method can include estimating static and/or dynamic formation properties from a variety of logging while drilling (LWD) measurements (e.g., including pressure, resistivity, sonic, and nuclear data) and optionally joint inversion of LWD and wireline (WL) measurements, which can provide for, at least, formation parameters that characterize a formation. As an example, where a method executes during drilling, LWD measurements may be utilized in a joint inversion to output formation parameters (e.g., formation parameter values) that may be utilized to guide the drilling (e.g., to avoid sticking, to diminish one or more types of formation damage, etc.).

In petroleum exploration and development, formation evaluation is performed for interpreting data acquired from a drilled borehole to provide information about the geological formations and/or in-situ fluid(s) that can be used for assessing the producibility of reservoir rocks penetrated by the borehole.

As an example, data used for formation evaluation can include one or more of core data, mud log data, wireline log data (e.g., wireline data) and LWD data, the latter of which may be a source for certain type or types of formation evaluation (e.g., particularly when wireline acquisition is operationally difficult and/or economically unviable).

As to types of measurements, these can include, for example, one or more of resistivity, gamma ray, density, neutron porosity, spectroscopy, sigma, magnetic resonance, elastic waves, pressure, and sample data (e.g., as may be acquired while drilling to enable timely quantitative formation evaluation).

Interpretation of measurements can provide a variety of information about formation properties. As an example, a LWD formation tester can be used to determine formation pressure and fluid mobility which can be utilized to optimize a drilling process as well as, for example, to help build one or more static reservoir models (e.g., when combining other log measurements).

As an example, LWD propagation resistivity measurements can be used for bed boundary detection which can inform geosteering and/or well placement. As an example, LWD propagation resistivity measurements may be used for formation resistivity determination.

As an example, multiple spaced receivers may provide capabilities of radial resistivity profiling which can be an indicator of mud-filtrate invasion. As an example, information from a joint inversion may be utilized to model and determine mud-filtrate invasion, optionally under one or more scenarios (e.g., mud types, mud densities, mud flow rates, drilling rate, drilling equipment, etc.).

As an example, LWD nuclear measurements can be used for determination of density and porosity, while azimuthal nuclear density images may be applied for boundary detection and dip picking.

As an example, sigma (e.g., formation capture cross section) is a volumetric measurement that can provide resistivity independent saturation which is particularly useful for some difficult scenarios such as, for example, drilling, casing, producing, etc. in the presence of formation carbonates, a high-angle portion of a well, a low resistivity pay, etc. (e.g., particularly where other resistivity measurements may not provide for accurate water saturation). As an example, a method can include recording sigma at multiple depths of investigation while drilling to help verify presence or absence of shallow mud-filtrate invasion and thereby improve quality of water saturation estimation from sigma.

As an example, neutron-capture spectroscopy can be used to perform elemental analysis for quantitative lithology determination, which can be used to improve a formation evaluation process, for example, with a reduced number of input parameters.

As an example, LWD sonic measurements can be used to estimate radial spatial distribution of formation elastic properties, which may be a function of porosity, mineral composition, mud-filtrate invasion, and mechanical damage effects introduced by drilling. In such an example, sonic measurements can allow for feedback of an ongoing drilling process. For example, a method can include receiving LWD sonic measurements and other measurements and inverting for increasing accuracy of a model that can be utilized to determine one or more parameters and/or parameter values for further drilling, for one or more completions, for one or more production schemes, for one or more injection schemes, etc.

As an example, one or more interpretation methods for LWD measurements can be extended from one or more of those used for the interpretation of corresponding wireline measurements; noting that interpretation of LWD measurements can present more challenges when compared with interpretation of wireline measurements.

As an example, LWD measurements can be acquired in high angle and/or a horizontal portion of a well. As such, techniques for interpretation can differ from those applied in a vertical portion of a well, for example, due to geometric effects and complicated borehole environments. In various situations, LWD measurements may be inherently noisier than wireline measurements because LWD measurements tend to be acquired in a dynamic drilling environment. When interpreting LWD measurements, there can also be less a priori information. Interpretation while drilling (IWD) can depend on various factors such as, for example, computational efficiency, particularly when real time interpretation is desired.

Referring again to FIG. 6, a single physics workflow can interpret a single type of measurement separately from one or more other types of single types of measurements. After two or more single types of measurements are interpreted, a multi-physics workflow may follow with a joint petrophysical interpretation. Such an approach may be referred to as two or more single physics interpretations followed by a multi-physics interpretation, which may be two or more single physics inversions followed by a multi-physics inversion of results from the two or more single physics inversions.

Where an interpretation is a single measurement interpretation, there can be associated non-uniqueness and uncertainty as to results. Such an approach can be particularly challenging when single measurements have different spatial resolutions and investigation depths that can make a joint interpretation ambiguous and more complex. As an example, consider that measurements with large investigation depth can be associated with low spatial resolution. For example, nuclear and NMR measurements can have quite high vertical resolution but the investigation depth tends to be quite shallow (e.g., of the order of a few inches or about 10 cm), while directional resistivity measurements can have resolution of feet (e.g., 50 cm or more) but can probe deeper into a formation (e.g., up to tens of feet or about 6 m or more). Inversion-based approaches associated with proper upscaling algorithms integrating multidisciplinary measurements may be implemented to provide adequate results. As an example, a near-bore model may be utilized in a joint inversion workflow where one or more dimensions of the near-bore model may be selected based at least in part on a type of measurement and/or a type of phenomenon that may occur that can affect a type of measurement (e.g., consider mud-filtrate invasion and its possible effect on one or more types of measurements).

Wireline resistivity logs are known to be affected by factors such as mud-filtrate invasion; whereas, LWD measurements tend to be less affected. However, invasion can still exist during LWD and it can be desirable to account for invasion in log interpretation. At the time of LWD, mud-cake may not be completely formed such that invasion may be actively ongoing, which may cause a supercharging phenomenon that can affect measurement of formation pressure. And, as invasion can be relatively rapid at such a stage, multiple passes of LWD may see time-lapse changes on logs.

For a more robust approach, a method can include integrated interpretation for LWD data. For example, a method can include applying one or more petrophysical joint inversion approaches for interpretation of LWD measurements. Such a method may optionally be extended for integrated interpretation of LWD and WL measurements, and/or time-lapse analysis of multi-pass LWD and/or WL measurements.

As an example, a method can provide for a systematic integration of multiple LWD measurements via a petrophysical joint inversion approach that takes into account radial alteration of formation properties and, for example, optionally integrated interpretation of LWD and WL measurements. Such an approach can be dynamic in that one or more dynamic aspects of formation properties (e.g., formation parameters) are taken into account.

As an example, a framework or frameworks can provide for integrated interpretation of multi-physics LWD measurements, or both LWD and WL measurements simultaneously, using a petrophysical joint inversion approach, which can output, at least, formation parameters that characterize a formation.

As an example, depending on data availability and/or sensitivity of data with regards to formation properties, an inversion workflow can be adjusted to multiple actions for a robust solution (e.g., less uncertainty, less risk of non-unique solution, etc.). In such an example, different physical processes can be coupled using petrophysical transforms such as, for example, one or more of Archie's law, the Gassmann equation, etc. Depending on geometric complexity and interpretation quality desired, different dimensions of modeling and inversion algorithms can be chosen from 1D through 3D (e.g., or 4D with respect to time). As an example, output from a workflow may include static and dynamic formation properties such as, for example, one or more of porosity, permeability, saturation, relative permeability, capillary pressure, etc. As an example, a workflow may output one or more of a calibrated rock physics model and a near-wellbore reservoir model (e.g., static and/or dynamic).

As an example, a method can directly link formation rock and fluid properties to acquired multi-tool measurements (e.g., multiple types of downhole tool measurements) through relevant petrophysical transforms that connect the various geophysical properties (e.g., resistivity, wave velocity, sigma, density, etc.) to rock and fluid properties in a near-wellbore formation. As an example, a near-wellbore formation or near-bore formation may be a region that can be defined at least in part by one or more radii. As an example, consider a region that can be defined by a maximum radius, which may be a maximum diameter. Such a dimension or dimensions may be selected, for example, based at least in part on one or more types of measurements (e.g., physics associated with a measurement or measurements) and/or one or more types of phenomena that may occur, which may occur for a period of time, responsive to a treatment, responsive to drilling, etc. As an example, a near-wellbore model may provide for modeling of formation and/or fluid properties at an interface between a bore space and a formation space. In such an example, the near-wellbore model may provide for modeling movement of fluid or fluids (e.g., single phase and/or multiphase) into a formation (e.g., from a bore space) and/or out of a formation (e.g., into a bore space). In such an example, a fluid may be a mud fluid, which can be drilling mud.

As an example, a direct link approach can include a simultaneous multi-physics inversion that is driven by underlying physics of measurements to estimate formation rock and fluid properties in a substantially consistent manner that maximally matches acquired data (e.g., different types of downhole tool measurements). As an example, a workflow can build a specific near-wellbore formation model that can be used to reproduce various desired types of measurements. Such a model can aim to honor physical processes based on a corresponding rock physical model. In such an example, interpretation results can be physically consistent across different types of measurements, which can mitigate non-uniqueness of data interpretation and hence reduce uncertainty of a resultant model.

As to various types of measurements, these can include, for example, borehole images, gamma ray, resistivity, density, neutron porosity, spectroscopy, sigma, elastic waves, and pressure. One or more techniques may be used to detect one or more boundaries and/or extract dip and azimuth information from one or more images and/or one or more logs.

As an example, initial porosity can be determined from sonic, neutron, or density logs, which may be, for example, fine-tuned in one or more subsequent inversions. As an example, quantitative mineralogy and rock matrix properties can be derived from neutron capture spectroscopy data using the SpectroLith lithology algorithm. As an example, formation permeability and irreducible water saturation can be estimated from lithology and total porosity using one or more empirical equations. As an example, sigma (formation capture cross section) can be a volumetric measurement that provides resistivity independent saturation limited to a few inches (e.g., 20 cm or less) of depth of investigation. As an example, formation salinity can be provided via resistivity-based and sigma-based saturation determination. As an example, a method can include estimating saturation and formation salinity simultaneously from resistivity and sigma under the condition that both measurements respond to a common region of a formation, or different regions but with consistent saturation and salinity values (e.g., not disturbed by invasion). As to such a condition, as an example, a workflow can, by accurately taking into account an invasion profile from fluid-flow simulation, relax an invasion related condition (e.g., to an appropriate extent). For example, if invasion has taken place, a radial distribution of saturation and salinity may be deemed appropriately accounted for to arrive at an acceptable interpretation of sigma and resistivity measurements; whereas, when invasion has not taken place, one or more other conditions may be imposed (e.g., or relaxed).

As an example, a workflow can include several modeling aspects associated with corresponding measurements to be solved to perform an inversion-based interpretation. Although mud-filtrate invasion effects tend to be relatively reduced on LWD logs compared with WL logs, measurements at shallow depth of investigation can still be affected by mud-filtrate, which can introduce errors into the estimation of saturation or porosity in gas reservoirs.

A mud-filtrate invasion process can be modeled by solving multiphase fluid flow equations (e.g., as for pressure testing data). As an example, if formation brine salinity is disturbed by mud-filtrate invasion, salt transport and mixing process may be simulated in connection with fluid flow. As an example, a resistivity tool response can be simulated by solving an appropriately formulated set of the Maxwell equations. As an example, a sonic tool response can be simulated by solving the wave propagation equations or other one or more methods such as ray-tracing, mode search, or an acoustic guidance condition, etc., depending on which sonic attribute is or sonic attributes are chosen for interpretation. As an example, the relationship between corresponding mineral grains, fluid components, and bulk sigma responses may be represented via a volumetric equation (e.g., a linear volumetric equation). As an example, a tool sigma response can be computed from a corresponding forward modeling solver or, for example, from a pre-defined sensitivity map (e.g., based at least in part on obtained spatial distribution of saturation and salinity in combination with formation mineral grains).

As mentioned, LWD measurements can be acquired in a high angle (Ha) portion or portions of a bore and/or a horizontal (Hz) portion or portions of a bore. The term horizontal may be defined according to accepted practice (see, e.g., FIG. 4 and various bore types and definitions). As mentioned, interpretation techniques used for vertical wells may not be satisfactorily appropriate or accurate for a high angle portion of a bore or a horizontal portion of a bore due to one or more geometric effects and/or one or more types of harsh bore environments. As mentioned, while LWD measurements tend to be less affected by the mud-filtrate invasion, the influence of shallow invasion and non-circular invasion geometry may still affect interpretation. As an example, an inversion-based interpretation framework can be implemented to perform a joint inversion or joint inversions based at least in part on downhole tool measurements and a near-bore model that can account for flow or flows of one or more fluids. In such an example, the framework can output, at least, formation parameters that characterize a formation. Such a framework may, for example, output a near-bore model, formation parameters and a calibrate rock physics model that characterize a formation.

As explained with respect to FIG. 6, as to a single type of measurement, a workflow can include forward modeling and inversion or inverting. As to multi-physics joint inversion, a workflow can include forward modeling that is based at least in part on a near-bore model (e.g., a near-wellbore model or a near-borehole model) and acquired data (e.g., measurements or measurement data or measurement information as acquired via two or more types of tools that are suitable for downhole use).

An article by Valdisturlo et al., (Improved Petrophysical Analysis in Horizontal Wells: From Log Modeling Through Formation Evaluation to Reducing Model Uncertainty—A Case Study, SPE-164881-MS, EAGE Annual Conference & Exhibition incorporating SPE Europec, 10-13 June, London, UK, 2013) is incorporated herein by reference. Valdisturlo et al. described a high angle and horizontal (HaHz) wells workflow that includes an iterative loop in which a geometry and formation property model is refined until an acceptable match between the simulated (forward modeled) and measured logs is achieved, which is followed by a hydrocarbons-in-place (HIP) calculation. The approach of Valdisturlo et al. utilized gamma ray (GR) and resistivity modeling where sections from a geological model were used to build a formation model in the proximity of a well where the formation model was verified based on LWD logs and image log analysis, refined and updated. In Valdisturlo et al., forward model simulations were performed for formation (FM) logs based on the model with layer properties and the relationship between the layers and the wellbore trajectory where manual refinement of the layered model and layer properties was performed until acceptable agreement was reached. A final petrophysical evaluation and structural model were used to update the existing geological model followed by a final HIP calculation.

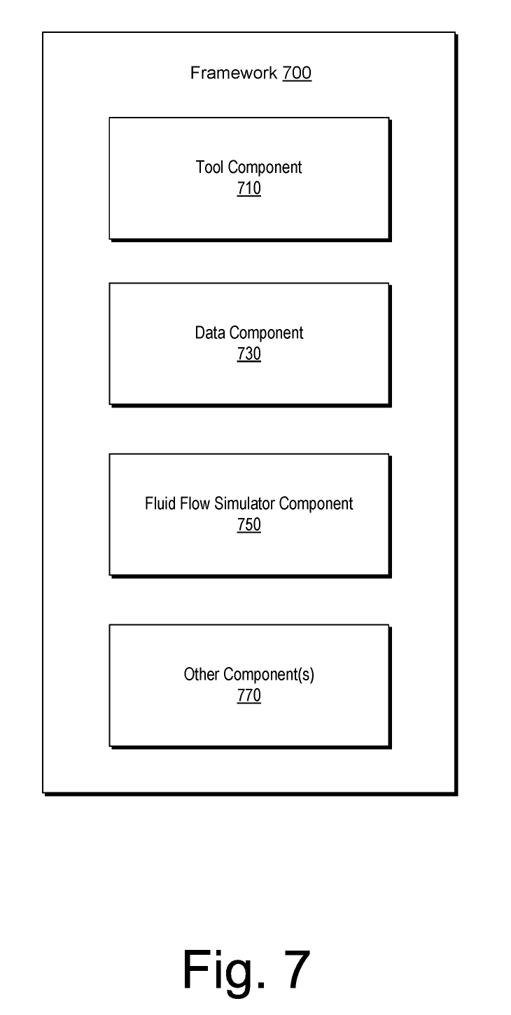

FIG. 7 shows an example of a framework 700 that includes a tool component 710, a data component 730, a fluid flow simulator component 750 and various other components 770.

As to the tool component 710, this can include one or more of the aforementioned tools, which can be, for example, one or more of the downhole measurement tools as described with respect to FIGS. 1, 2, 3, 4 and 5.

As to the data component 730, it can include one or more features of a commercially available framework such as, for example, the TECHLOG® framework. The TECHLOG® framework includes features for wellbore-centric, cross-domain workflows to different disciplines: petrophysics, geology, geophysics, drilling, and reservoir and production engineering. The TECHLOG® framework provides an integrated data reception and processing environment to process bore data and deliver results. The TECHLOG® framework includes a user interface for project management, a graphical zonation interface and zone manager, as well as a trend line object that can be applied across multiple wells. The TECHLOG® framework includes a production logging that includes a log simulator powered by OLGA and an enhanced array tool workflow supporting tools from various oilfield service companies. The TECHLOG® framework includes a pore pressure prediction feature that includes an interface and associated functionalities. The TECHLOG® framework includes a wellbore stability feature that can provide for sanding analysis and anisotropic geomechanics workflows.

The TECHLOG® framework includes: core systems features such as BASE, C-Data-API, CoreDB, Real Time, TechData-Plus, TechStat, and Viewer; geology features such as Advanced Plotting, Field Map, Ipsom, K.mod, and Wellbore Imaging (Wbi); geomechanics features such as Completion Geomechanics, Pore Pressure Prediction, and Wellbore Stability; geophysics features such as Acoustics and Geophy; petrophysics features such as 3D Petrophysics, Acoustics, Nuclear Magnetic Resonance (NMR), Quanti., Quanti.Elan, TechCore and Thin Bed Analysis (TBA); production features such as Cased Hole, Production Logging, and Wellbore Integrity; reservoir engineering features such as Fluid Contact, Formation Pressure, Saturation-Height Modeling (SHM), and TechCore; and shale features such as Unconventionals and Quanti.Elan.

As mentioned, in high angle and horizontal wells it can be challenging to apply various petrophysical interpretation techniques that are used in vertical wells, due to geometric effects on the data in particular the resistivity logs. Such effects can include local layering or resistivity anisotropy, and boundary effects such as proximity and polarization horns on the resistivity measurements. Other effects complicating a borehole environment can include asymmetric invasion profiles, the presence of cuttings beds and drilling mud segregation. A method can include processing measurements to arrive at petrophysical properties that can be utilized in a model to reduce uncertainty and improve model accuracy.

As to the fluid flow simulator component 750, it can include one or more features of one or more commercially available frameworks such as, for example, the ECLIPSE® framework and the INTERSECT® framework.

As to fluid flow simulation of an unconventional reservoir, the fluid flow simulator component 750 can account for one or more of nano-darcy permeabilities, complex fracture networks from natural or induced fractures, and adsorbed gas in organic materials in the rock matrix. As an example, the ECLIPSE® framework coal and shale gas feature may be implemented for complex physics associated with such phenomena for purposes of modeling. For example, consider utilization of a dual porosity model including two interconnected systems representing the rock matrix and the permeable rock fractures, a multiporosity model that enables detailed study of transient behavior in the matrix, and adsorption and diffusion based on Langmuir isotherms, including the option to model time-dependent diffusion. As an example, a framework may include accounting for one or more rock compaction effects.

As an example, the fluid flow simulator component 750 may be operatively coupled with another framework such as, for example, the PETREL® framework, the OCEAN® framework and/or the TECH LOG® framework.

As an example, a framework or frameworks can provide for performing rate transient analysis, studying reservoir connectivity and fault transmissibility, determining sensitivity to particular uncertain parameters, and/or designing wells and completion configurations.

As an example, the PETREL® framework may be operatively coupled to one or more of the INTERSECT® reservoir simulator and the ECLIPSE® reservoir simulator, enabling truly integrated reservoir simulation studies and field development projects.

As an example, a model suitable for use with one or more fluid flow simulators may be built based at least in part on seismic data for a geologic environment. Such a model may be refined in a near-bore region of the geologic environment based at least in part on data acquired by one or more downhole tools. As an example, the TECHLOG® framework may be operatively coupled to the PETREL® framework, which may be operatively coupled to the ECLIPSE® framework (e.g., fluid flow simulator thereof) and/or the INTERSECT® framework (e.g., fluid flow simulator thereof).

In the example of FIG. 7, the one or more other components 770 can include particular components for determination of measurement values based at least in part on output of the fluid flow simulator 750 component.

As an example, the framework 700 may be implemented to perform a method that includes forward modeling and inversion (e.g., inverting).

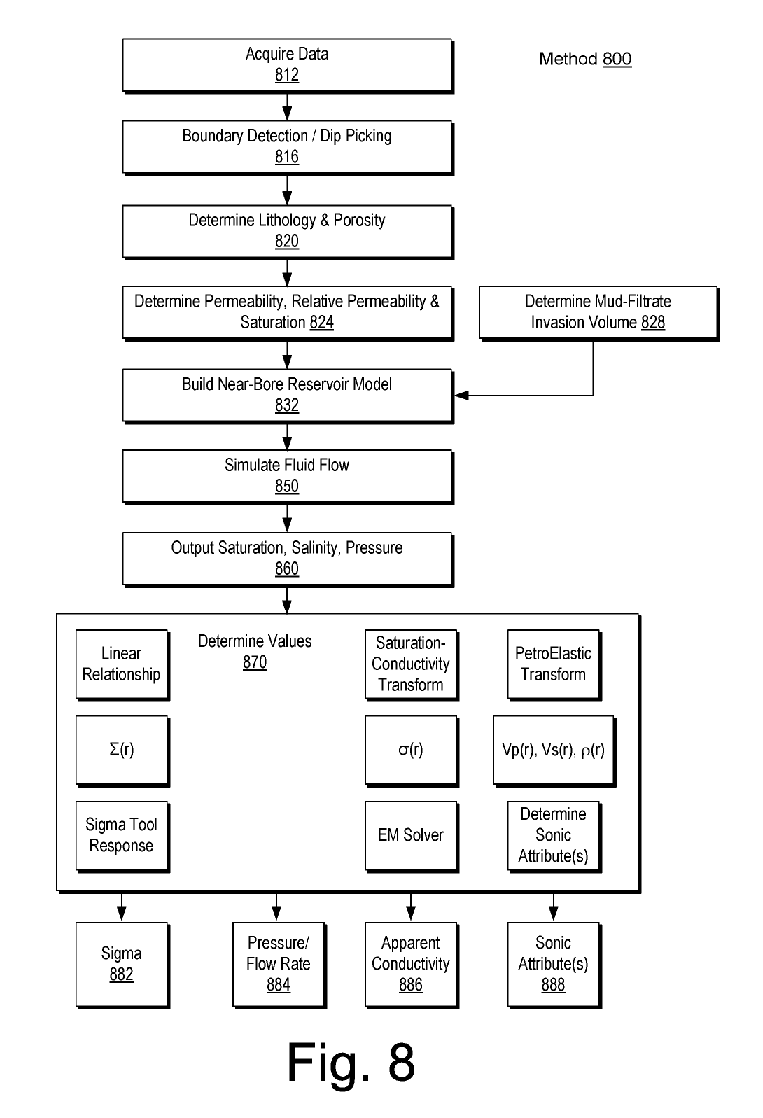

FIG. 8 shows an example of a method 800 that includes an acquisition block 812 for acquiring data, a detection and picking block 816 for boundary detecting and dip picking, a determination block 820 for determining lithology and porosity, a determination block 824 for determining permeability, relative permeability and saturation, a determination block 828 for determining a mud-filtrate invasion volume, a build block 832 for building a near-bore reservoir model based at least in part on output of the blocks 824 and 828 (e.g., based at least in part on permeability, relative permeability, saturation and mud-filtrate invasion volume), a simulation block 850 for simulating fluid flow based at least in part on the near-bore reservoir model, an output block 860 for outputting saturation, salinity and pressure based at least in part on the simulating (e.g., fluid flow simulation results), a determination block 870 for determining values for sigma 882, pressure and/or flow rate 884, apparent conductivity 886 and one or more sonic attributes 888. In such an example, the method 800 can include modeling and compute resistivity tool responses, sonic tool responses or attributes, and sigma tool responses at corresponding logging times. For example, the values for sigma 882, pressure and/or flow rate 884, apparent conductivity 886 and one or more sonic attributes 888 may be modeled and computed values at one or more corresponding logging times for corresponding locations in a bore of a region (e.g., a region where measurements may be acquired).

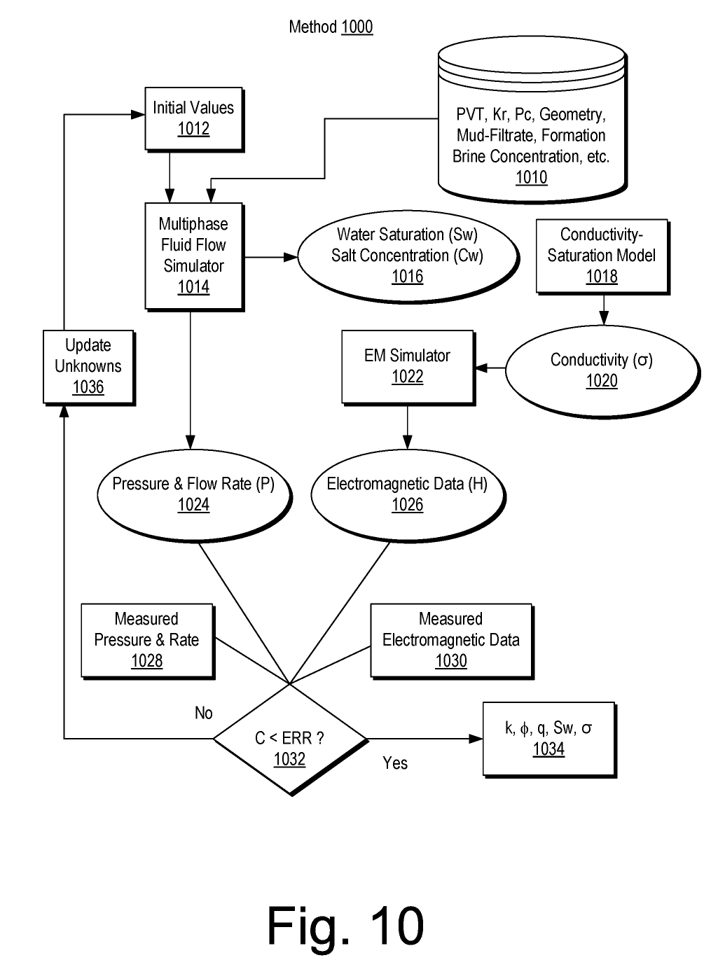

In the example of FIG. 8, the output block 860 can output saturation, salinity and pressure with respect to spatial location(s) (e.g., “r”) and with respect to time(s) (e.g., “t”). In such an example, the output block 860 can output values for saturation, values for salinity and values for pressure that can correspond to a spatial location of at least one downhole tool, for example, for a particular time, which may be a time associated with presence of a bore in a formation (e.g., where an initial time may be a time where flow into and/or out of the bore and/or the formation may commence). In such an example, flow can include mud-filtrate flow such as mud-filtrate invasion as a type of fluid flow (see, e.g., the method 1000 of FIG. 10).

As mentioned, mud-filtrate invasion and/or timing thereof (e.g., and/or mud-cake formation, etc.) may affect one or more types of measurements acquired by one or more corresponding types of downhole tools. Such an approach may more accurately provide for joint inversion where mud-filtrate invasion has taken or is taking place. As mentioned, without accounting for mud-filtrate invasion, errors may exist in measurement values, which may propagate to a model and/or its parameters (e.g., parameter values, etc.). A method such as the method 800 of FIG. 8 can account for mud-filtrate invasion to provide more accurate output of fluid flow simulation results that can be “transformed”, as appropriate, into simulated measurement values for purposes of comparison to actual measurement values. As mentioned, a fluid flow model can include a near-bore (e.g., near-wellbore or near-borehole) region such that mud-filtrate invasion can be modeled for a location or locations (e.g., and time or times) of downhole tools that may be utilized to acquire measurement values. Such downhole tools can include at least one LWD tool and/or at least one WL tool. Such downhole tools can provide for multi-physics measurement values (e.g., measurement values for two or more types of physically detectable characteristics and/or phenomena).

As an example, the method 800 may be implemented at least in part via the framework 700 of FIG. 7. For example, the data component 730 may be implemented to perform actions of the blocks 812, 816, 820, 824 and 832 and the fluid flow simulation component 750 may be implemented to perform actions of the block 850. In such an example, the near-bore reservoir model may be built using a framework such as the PETREL® framework and the fluid flow simulation may be performed using the ECLIPSE® framework and/or the INTERSECT® framework. In the example of FIG. 8, the block 870 may be implemented using one or more of the one or more other components 770 of the framework 700 of FIG. 7. As an example, such components may be add-ons, plug-ins, etc. that can be operatively coupled to a fluid flow simulator, for example, to receive simulation results from fluid flow simulation of a region that includes a near-bore region.

In the example of FIG. 8, the method can include determining sigma 882 via a linear relationship and a sigma tool response model, can include determining apparent conductivity via a saturation-conductivity transform and an electromagnetic (EM) solver, and can include determining one or more sonic attributes via a petroelastic transform, velocities and density (or densities). As shown in the example of FIG. 8, the pressure and/or flow rate 884 may be determined via output of the fluid flow simulation, for example, as a direct and/or indirect result (e.g., directly output from a fluid flow simulator and/or determined based at least in part on output from a fluid flow simulator).

As an example, the acquisition block 812 can include acquiring LWD logs (e.g., including time-lapse logs) and/or wireline logs as measurements. Such a block can also aim to collect other prior information such as, for example, geology, depositional environment, rock types, fluid properties, formation salinity, clay CEC, time stamps of logs, etc.

As an example, the detection and picking block 816 can include detecting boundaries and extracting dip and azimuth information from borehole images or logs.

As an example, the determination block 820 can include analyzing lithology quantitatively and determining porosity.

As an example, the determination block 824 can include computing permeability, relative permeability, and water saturation using one or more techniques.

As an example, the build block 832 can include building a near-wellbore reservoir model based on output of one or more of the blocks 812, 816, 820 and 824, as well as, for example, the determination block 828 (e.g., as to invasion).

As an example, the simulation block 850 can include running a reservoir simulation to compute temporal and spatial distribution of fluid properties and to obtain time-dependent pressure and/or flow rate response in a wellbore (e.g., the wellbore of the near-bore reservoir model).

As an example, determination block 870 can include transforming fluid and rock properties at the time of logging into, for example, conductivity, elastic properties, and sigma using relevant formulae. As mentioned, the method 800 can include modeling and computing resistivity tool responses, sonic tool responses or attributes, and sigma tool responses at corresponding logging times.

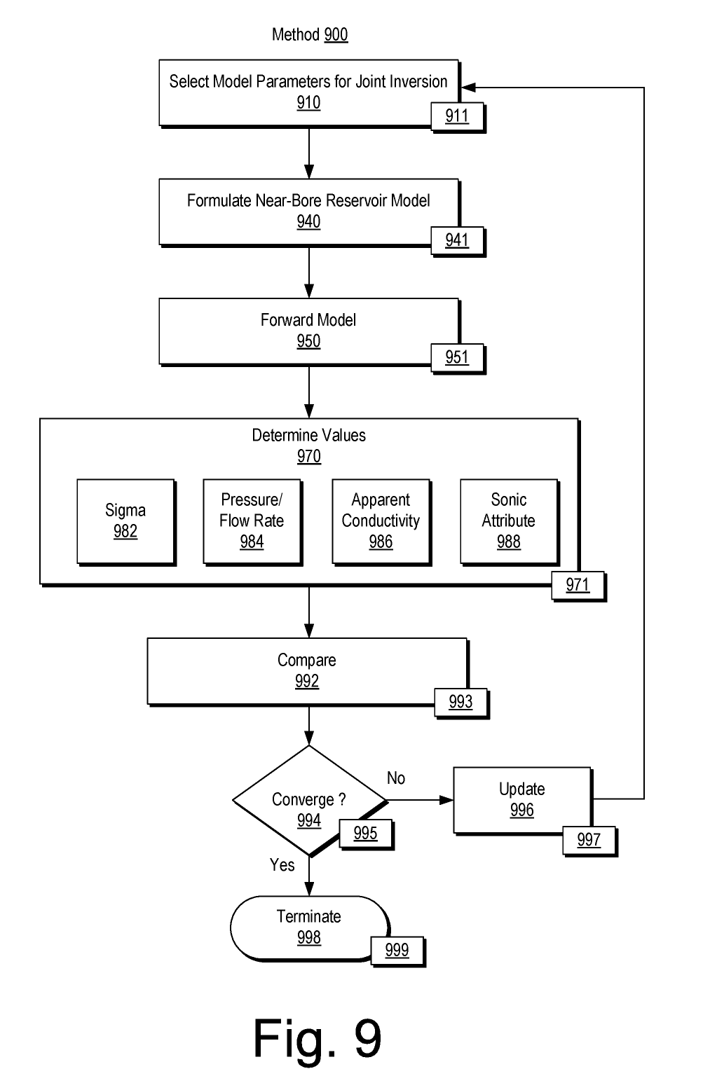

FIG. 9 shows an example of a method 900 that includes a selection block 910 for selecting model parameters to be inverted, for example, based on the sensitivity of data to these parameters; a formulation block 940 for formulating a near-bore reservoir model; a forward modeling block 950 for forward modeling of physical phenomena based at least in part on the formulated near-bore reservoir model; a determination block 970 for determining values for at least one of sigma 982, pressure and/or flow rate 984, apparent conductivity 986 and one or more sonic attributes 988; a comparison block 992 for comparing simulated tool responses (e.g., simulated tool measurements) with recorded measurements (e.g., downhole tool measurements); a decision block 994 for deciding whether convergence has been achieved for the simulated tool responses and the recorded measurements; an update block 996 for updating the selection of model parameters for joint inversion where the decision block 994 decides that convergence has not been achieved; and a termination block 998 for terminating the method 900 (e.g., responsive to one or more convergence criteria not being met per the decision block 994).

As an example, the decision block 994 may decide whether one or more residuals is not sufficiently small when compared to a predetermined value, a percentage, etc. As an example, the decision block 994 may operate according to a counter that causes the method 900 to be directed to the termination block 998 depending on a number of iterations (e.g., a maximum number of iterations).

In the example of FIG. 9, the termination block 998 can include outputting inverted parameter values, for example, where a residual is or residuals are sufficiently small.

As an example, in the method 900, after inversion, pre-selected formation parameters can be determined while also having obtained a near-bore reservoir model that can be used to replicate downhole measurements (e.g., and optionally a calibrated rock physics model).

The method 900 of FIG. 9 includes various blocks 911, 941, 951, 971, 993, 995, 997 and 999 that represent computer-readable storage medium (CRM) blocks or processor-readable medium blocks. Such blocks can include instructions that are computer-executable and/or processor-executable. A computer-readable storage medium is non-transitory, not a signal and not a carrier wave. A computer-readable storage medium is a physical component or components.

As an example, the framework 700, the method 800 and/or the method 900 may be tailored in a manner that is specific to an application and/or a scenario, which may be in a manner depending on measurement availability, data sensitivity, and formation structural complexity. As an example, the method 800 may be considered to be a forward modeling method and the method 900 of FIG. 9 may be considered to be an inversion method, which includes forward modeling (e.g., a forward modeling method).

While the blocks 870 and 970 of the methods 800 and 900 include some examples of measurements, measurements suitable for use with such methods can include one or more of resistivity measurements, gamma ray (GR) measurements, density measurements, neutron porosity measurements, spectroscopy measurements, sigma measurements, magnetic resonance measurements (e.g., NMR, MRI, etc.), elastic wave measurements, pressure measurements, etc.

As an example, a method can include reservoir mapping while drilling (e.g., to reveal multiple formation boundary layers and fluid contacts to optimize well landing and increase reservoir exposure, etc.).

As an example, a method can include petrophysics while drilling (e.g., evaluation of lithology, porosity, saturation, and permeability properties while drilling to facilitate timely, informed decisions, etc.).

As an example, a method can include geology while drilling (e.g., to inform drilling decisions with high-resolution, real-time imaging to identify formation structure, faults, and fractures, etc.).

As an example, a method can include geomechanics while drilling (e.g., consider compressional and shear slownesses and Stoneley wave data delivered by a tool such as the SONICSCOPE™ multipole sonic-while-drilling tool and associated technology, etc.).

As an example, a method can include geophysics while drilling (e.g., consider a look-ahead technology with the SEISMICVISION™ seismic-while-drilling tool and associated technology for time-depth-velocity information in real time, etc.).

As an example, a method can include reservoir engineering while drilling (e.g., consider measuring formation pressure while drilling to accurately model dynamic reservoir pressure and target productive zones, etc.).

As an example, a method can include implementing geosteering and/or geostopping technologies, optionally with real-time LWD measurement data to improve well positioning, increase rate of penetration (ROP), maximize reservoir exposure and enhance production, etc.

As an example, a method can include implementing one or more measurements while drilling tools and associated technologies. For example, a method can include acquiring formation evaluation and drilling optimization data during drilling operations to guide well placement and to provide data for survey management and development planning, etc.

As an example, a method can include measuring formation properties during excavation of a bore (e.g., or shortly thereafter) through the use of tools integrated into a bottom hole assembly (BHA). As an example, a method can include measuring properties of a formation before drilling fluids invade deeply. As an example, measurements may be used to guide well placement so that a wellbore remains within a desired zone of interest or in a productive portion of a reservoir, which can be a desirable process in a variable shale reservoir.

As an example, a method can include measurement while drilling (MWD). Such a method can include evaluation of physical properties (e.g., pressure, temperature and wellbore trajectory in three-dimensional space) while extending a bore. As an example, measurements made downhole can be transmitted and/or stored in memory and later transmitted to the surface or otherwise received (e.g., accessed). Some types of tools can store measurements for later retrieval with wireline or when the tool is tripped out of the hole. MWD tools that measure various formation parameters (e.g., resistivity, porosity, sonic velocity, gamma ray, etc.) can be referred to as logging-while-drilling (LWD) tools; noting that LWD tools can utilized data storage and/or data transmission technologies. As an example, a tool can include memory that provides for storage of higher resolution logs than real-time transmitted LWD logs, which may be transmitted via one or more techniques (e.g., mud-pulse data transmission, etc.).

A wireline tool may allow for acquisition of a relatively continuous measurement of one or more formation properties. As an example, a tool can be an electrically powered instrument that may, for example, allow for inference as to one or more formation properties, which can facilitate decision making as to drilling and/or production operations.

As mentioned, various types of measurements may be made via a downhole tool. Such measurements can include, for example, electrical property measurements (e.g., resistivity and conductivity at various frequencies, etc.), sonic property measurements, active and passive nuclear measurements, dimensional measurements of a bore, formation fluid sampling, formation pressure measurements, wireline-conveyed sidewall coring tools, etc.

As an example, a logging tool can be lowered into an open bore via a multiple conductor, contra-helically armored wireline cable. Once the tool string has reached a desired location (e.g., a bottom of an interval of interest), measurements may be taken while pulling the tool out of the bore, which may aim to maintain tension on a cable (which tends to stretch) to allow for depth correlation.

In various hostile environments, in which the tool electronics might not survive the downhole temperatures for long enough to allow a tool to be lowered to a bottom of a bore and measurements to be recorded while pulling the tool up, measurements may be made in a “down log” manner and, for example, optionally repeated on the way.

As to logging while drilling (LWD), tools can take measurements while drilling proceeds in a downward manner as a bore is deepened. As an example, when pulling a drillstring uphole (tripping out of hole or pulling out of hole), a method may include acquiring measurements during an upward trip and/or at one or more stationary positions (e.g., whether tripping up or tripping down).

As an example, the method 800 may include setting the mud-filtrate invasion volume to a null value (e.g., zero), determining that a mud-filtrate invasion volume is negligible, and/or disabling the determination block 828. In such an example scenario, the absence of mud-filtrate invasion is a special case (e.g., where the mud-filtrate invasion volume is set to zero). As an example, depending on the formation geometric complexity which may, for example, be judged from the boundary detection and dip picking block 816, different model dimensions may be selected, for example, from a set of model dimensions including 1 D, 2D, and 3D. In such an example, the model may be parameterized in one or more other manners (e.g., pixel-based or model-based). As an example, a method can after inversion, obtain a set of optimized pre-selected static and dynamic formation properties which may include porosity, permeability, saturation, relative permeability, capillary pressure, and so on, as well as a calibrated rock physics model and a static near-wellbore reservoir model.

As an example, a method can include performing a petrophysical joint inversion that accounts for radial alteration of formation properties and interpretation of LWD measurements and optionally WL measurements.

As an example, a method can provide for interpretation of multi-physics LWD measurements, or both LWD and WL measurements simultaneously, using a petrophysical joint inversion approach. Depending on data availability and sensitivity of data with regards to formation properties (e.g., formation parameters), an inversion workflow can be adjusted for a more robust solution. As an example, different physical processes can be coupled using petrophysical transforms such as one or more of Archie's law, the Gassmann equation, etc. Depending on the geometric complexity and the interpretation quality desired, different dimensions of modeling and inversion algorithms can be selected (e.g., 1D, 2D, 3D, or 4D). As an example, a workflow may include static and dynamic formation properties such as one or more of porosity, permeability, saturation, relative permeability, capillary pressure, etc. Values for such formation properties may be output as a result of implementation of such a workflow, optionally along with one or more of a calibrated rock physics model and a near-bore model (e.g., a near-bore reservoir model).

FIG. 10 shows an example of a method 1000 as to a joint inversion where initial values of unknown parameters (e.g., permeability, porosity and mud-filtrate invasion rate) per block 1012 and additional information such as PVT, Kr (relative permeability), Pc (capillary pressure), formation geometry, mud-filtrate and formation brine concentration, etc., per block 1010 are received for building a reservoir model. A multiphase fluid flow simulator block 1014 can be run on the reservoir model generated from the data per block 1010 and the initial parameter values per block 1012, thereby generating spatial distributions per block 1016 of water saturation and salt concentration. As shown, a conductivity-saturation model per block 1018 can be used to transform the spatial distributions per block 1016 into a conductivity distribution per block 1020. As shown, an electromagnetic simulator per block 1022 generates simulated electromagnetic data per block 1026 based on the input conductivity distribution per block 1020. Simulated pressure and flow rate data per block 124 are generated by a multiphase fluid flow simulator per block 1014. As shown, the pressure and flow rate data per block 1024, and electromagnetic data per block 1026, measured pressure and flow rate data per block 1028, and measured electromagnetic data per block 1030 are input into a cost function (C) per block 1032. As an example, the cost function per block 1032 can be a combination of differences of values of blocks 1024 to 1028, and blocks 1026 to 1030. As shown, at block 1036, values can be updated for permeability, porosity and mud-filtrate invasion rate per block 1012 until the cost function per block 1032 becomes less than a predefined tolerance (e.g., criterion, etc.), thereby yielding the inverted parameters and derived distributions of water saturation and conductivity per block 1034. The method 1000 of FIG. 10 may be utilized as to estimation of various petrophysical parameters and a mud-filtrate invasion profile via a joint induction and pressure data inversion approach (Liang et al., entitled “A method to estimate petrophysical parameters and mud-filtrate invasion profile using joint resistivity data and pressure transient data inversion approach”, US 20100185393A1, 22 Jul. 2010, is incorporated by reference herein).

In the example of FIG. 10, the method 1000 pertains to an inversion approach for interpreting geophysical electromagnetic data. Such an inversion can be constrained by using a multiphase fluid flow simulator (e.g., incorporating pressure data if available) which simulates the fluid flow process and calculates the spatial distribution of the water saturation and the salt concentration, which are in turn transformed into the formation conductivity using a resistivity-saturation formula. In such an example, an inverted invasion profile can be more consistent with fluid flow physics and, for example, can account for gravity segregation effects. Jointly with the pressure data, the inversion approach of the method 1000 of FIG. 10 estimates a parametric one-dimensional distribution of permeability and porosity. As an example, fluid flow volume can be directly inverted from a fluid-flow-constrained inversion of the electromagnetic data. A joint inversion of electromagnetic and pressure data can provide for a more reliable interpretation of formation permeability. Such an approach can be utilized, for example, in three-dimensional geometries (e.g., dipping beds and/or highly deviated wells).

One or more features of the method 1000 of FIG. 10 may be utilized for estimating a fluid invasion rate for one or more portions of a subterranean formation of interest surrounding a borehole. Such an approach can include receiving electromagnetic survey data of a subterranean formation of interest and receiving fluid flow characteristics relating to the formation of interest. As an example, a direct inversion can be performed of electromagnetic data as constrained by a fluid flow simulator for a fluid invasion rate such that the fluid invasion rate is thereby estimated. As an example, fluid can be mud filtrate and/or completion fluid. As an example, a fluid flow simulator can be used to generate pressure transient data as to a borehole. In such an example, if the pressure transient measurements are available to be compared with those generated from a fluid flow simulator then permeability can be estimated. As an example, porosity may be estimated based on an inversion. As an example, a quantitative predictive formation model can be generated based on an inversion. As an example, electromagnetic data can be obtained using various tools operated in a bore (e.g., a wellbore, etc.). Various features of the method 1000 of FIG. 10 may be utilized as to one or more different configurations as to data acquisition such as cross-well, surface to borehole, borehole to surface and surface to surface.

As an example, during development of a field, in a drilled borehole, mud-filtrate can invade into surrounding rock formation. In such an example, a three-phase, four-component (oil, water, gas, salt) model may be employed to describe a mud-filtrate invasion process. For example, mud-filtrate invasion can be simulated as an injection process by solving a pressure diffusive equation derived from Darcy's Law and a mass balance equation. Such equations can be solved numerically using a finite-difference based reservoir simulator in fully implicit, black-oil mode with a brine tracking option. For example, consider utilization of the ECLIPSE® reservoir simulator with an appropriate finite-difference discretization of a region of interest (e.g., a gridded region of interest). As an example, a pressure transient in a well/formation test can be simulated as well as the temporal and spatial distribution of phase saturation and salt concentration. As an example, a scenario can include simulation of a subterranean region that includes a bore that penetrates a layered hydrocarbon bearing formation or formations of the subterranean region. As an example, as to a bore and formation or formations, a cylindrical axisymmetric grid or other type of grid may be utilized for discretization of equations to be solved via a numerical simulator. As an example, a logarithmic radial grid with relatively fine grid cells around a bore may be utilized to capture mud-filtrate invasion and/or one or more other phenomena that may be associated with one or more logging techniques, whether employed via LWD and/or WL. As an example, a grid may be suitable for simulating pressure transient phenomena in a well/formation test, etc.

As an example, a near-bore (e.g., a near-wellbore or near-borehole) model can extend from a surface of a formation that defines the bore into the formation by a distance of the order of 0.5 meters, meters, or one hundred meters or more, which may depend on one or more types of measurements to be jointly inverted and/or one or more types of phenomena (e.g., fluid related, chemically related, time related, etc.). As an example, a dimension associated with a near-bore model may be a radius, a diameter, a dimension of a polygon, etc. As an example, for pressure measurements, the radial extension of a near-bore model could be of the order of one hundred meters or more. As an example, for relatively shallow radial resistivity changes and/or mechanical formation damage, a near-bore model may extend a radially a distance of approximately a meter (e.g., few feet). As an example, where a resistivity perturbation is relatively deep, a near-bore model may extend a few meters or more (e.g., tens of feet, etc.), particularly when using deep LWD resistivity measurements. As an example, a bore in a formation may include a cross-sectional dimension of approximately 5 cm to approximately 1 m, which may be, for example, a diameter of a bore (e.g., borehole or a wellbore); noting that a radius may be approximately one half of such a dimension. As to length, a bore in a formation may extend a distance of meters, which may be of the order of 1000 m (e.g., 1 km) or more.

As an example of a formation, consider the Bakken formation, which is a rock unit from the Late Devonian to Early Mississippian age occupying about 200,000 square miles (520,000 km²) of the subsurface of the Williston Basin. As an example, a well can be drilled and completed in the middle member of the Bakken formation and/or, for example, the basal Sanish/Pronghorn member, in the underlying Three Forks Formation, etc.

Porosities in the Bakken formation can average about 5 percent and permeabilities can tend to be low, averaging approximately 0.04 millidarcies. The presence of vertical to sub-vertical natural fractures makes the Bakken a candidate for horizontal drilling techniques where, for example, at least a portion of a well may be drilled horizontally (e.g., along bedding planes). In such an approach, a bore can contact hundreds of meters of reservoir rock in a unit that may have a maximum thickness of only about 40 meters (e.g., about 140 feet). As an example, production may be enhanced by artificially fracturing rock (e.g., via hydraulic fracturing).

As mentioned, a method can include estimation of static and/or dynamic formation properties from a variety of logging while drilling (LWD) measurements and optionally wireline (WL) measurements (e.g., pressure, resistivity, sonic, nuclear data, etc.). Such a method can include joint inversion of multi-physics downhole tool measurements, which may be multi-physics from one or more types of tools (e.g., LWD tools and/or WL tools). As mentioned, mud-filtrate invasion is an example of a type of dynamic process that can dynamically alter formation properties in a near-bore region, which may affect one or more types of downhole tool measurements.

As an example, one or more features of the method 1000 of FIG. 10 may be utilized with respect to the method 800 of FIG. 8 and/or the method 900 of FIG. 9 where data include measurement data from LWD and/or WL. As an example, the determination block 828 of FIG. 8 may be implemented using one or more features of the method 1000 of FIG. 10, for example, to determine information as to mud-filtrate invasion in a bore where LWD and/or WL measurements are acquired (e.g., have been acquired, are to be acquired, etc.).

As an example, a method for performing an inversion of data from downhole data can include placing a set of tools into a downhole environment; acquiring data from the tools in the downhole environment; determining a presence of boundaries in the acquired data; performing a lithology and a porosity analysis on the acquired data; computing at least one of permeability, relative permeability and water saturation on the acquired data; building a near-wellbore reservoir model; performing a reservoir simulation; transforming fluid and rock properties into conductivity, elastic properties and sigma, etc.; and modeling and computing relevant tool responses.

As an example, a method for inversion of data can include placing a set of tools into a downhole environment; acquiring data from the tools in the downhole environment; selecting model parameters to be inverted based on the sensitivity of data where, with respect to these parameters, the method can include obtaining simulated responses from the forward modeling; and comparing the simulated responses to the acquired data. As an example, such a method can include updating one or more of the selected model parameters and repeating the method if a difference between the simulated responses and the acquired data is above a threshold value (e.g., a convergence criterion, etc.). As an example, such a method can include outputting inverted parameters (e.g., parameter values) when the difference between the simulated responses and the acquired data is below a threshold value.

As an example, a method can include one or more of obtaining a near-wellbore reservoir model from an inversion and obtaining a calibrated rock physics model from the inversion and inverted parameters.

As an example, a method can include receiving data from one or more tools, which can include one or more logging while drilling measurement tools and/or one or more wireline tools.

As an example, a method can include determining dip and azimuth information.

As an example, a method can include joint inversion of logging while drilling measurements and/or wireline measurements, which may include time-lapse measurements.

As mentioned, a petrophysical joint inversion approach can take into account the radial alteration of formation properties and integrated interpretation of LWD measurements and/or WL measurements.

In reservoir characterization, a petrophysical model can be utilized to interpret petrophysical measurements (e.g., petrophysical data). A framework for petrophysical interpretation may include instructions for calculation of shale volume, calculation of total porosity, calculation of effective porosity, calculation of water saturation, calculation of permeability. A petrophysical model may be calibrated, for example, using core, production, test and/or other data.

As an example, multi-physics joint inversion can be implemented to obtain a set of optimized pre-selected static and/or dynamic formation properties which may include porosity, permeability, saturation, relative permeability, capillary pressure, etc. and to obtain a calibrated rock physics model and a static near-bore model (e.g., a static near-bore model) or, optionally, a dynamic near-bore model where time is a dimension.

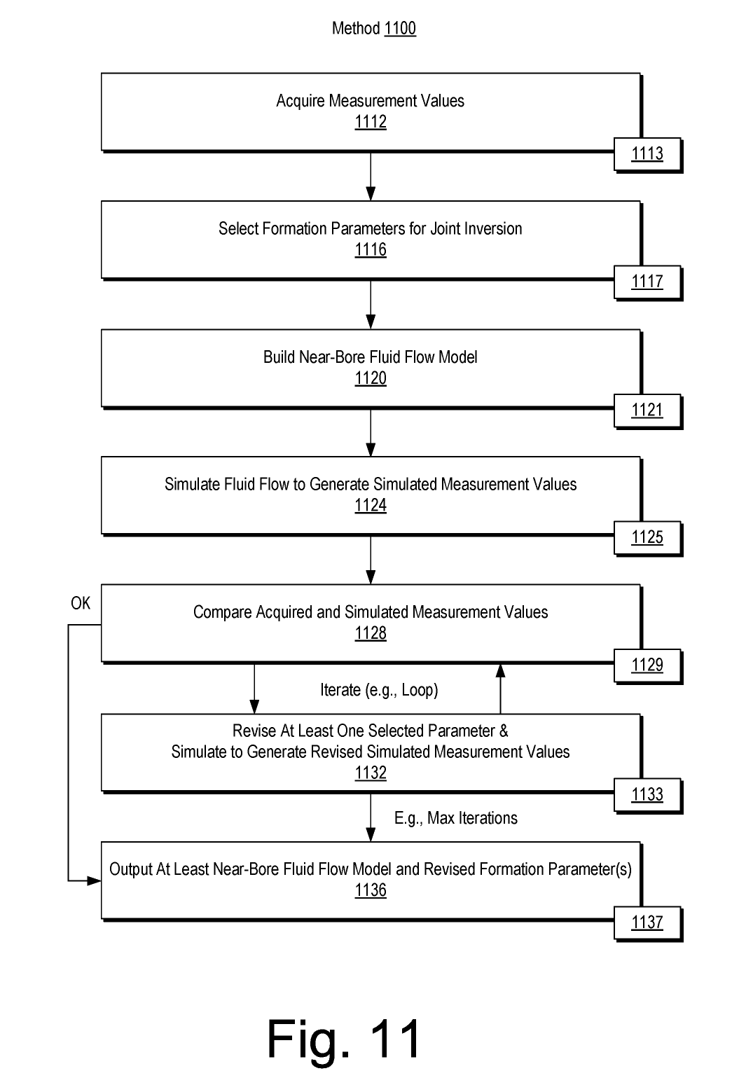

FIG. 11 shows an example of a method 1100 that includes an acquisition block 1112 for acquiring measurement values from at least two different types of downhole tools disposed in a portion of a bore in a formation; a selection block 1116 for selecting formation parameters for joint inversion; a build block 1120 for building a near-bore fluid flow model of at least a portion of the formation that includes at least the portion of the bore; a simulation block 1124 for simulating fluid flow based at least in part on the near-bore fluid flow model and the selected formation parameters to generate simulated measurement values; a comparison block 1128 for comparing the acquired measurement values and the simulated measurement values; a revision block 1132 for, based at least in part on the comparing, revising at least one of the selected formation parameters to generate revised formation parameters and simulating fluid flow based at least in part on the near-bore fluid flow model and the revised formation parameters to generate revised simulated measurement values; and an output block 1136 for outputting at least the revised formation parameters where the revised formation parameters characterize the formation. In such an example, a selected formation parameter may be a parameter value and a revised formation parameter may be a revised formation parameter value and/or a selected formation parameter may be a formation parameter selected from a group of formation parameters and a revised formation parameter may be a revised selection of a formation parameter selected from a group of formation parameters. The method 1100 of FIG. 11 can include, for example, outputting the near-bore model and/or a calibrated rock physics model, which can be considered results of the method.

As shown in FIG. 11, the method 1100 can proceed from the comparison block 1128 to the output block 1136, for example, based on a favorable comparison. As shown in FIG. 11, the method 1100 can iterate between the revision block 1132 and the comparison block 1128, for example, until a favorable comparison is reached or, for example, until a maximum number of iterations occurs (e.g., or one or more other criteria for proceeding to the output block 1136).

As an example, a method can include honing formation parameters values for selected formation parameters based on joint inversion of multi-physics measurements acquired via two or more downhole tools. In such a method, simulated measurement values may be determined based on formation parameter values utilized by a simulation model, which may be a near-bore model. Such simulated measurement values can be compared to actual measurement values as acquired via two or more downhole tools where revisions can be made as to one or more of the formation parameters values until acceptable convergence is achieved between the simulated measurement values and the actual measurement values. Such a method may optionally be implemented in real-time during a downhole operation (e.g., LWD, WL, etc.) in a formation (or formations) where one or more of iteratively honed formation parameters values, a near-bore model, a rock physics model, etc. may be utilized to guide (e.g., plan, control, etc.) one or more operations associated with the formation (or formations).

The method 1100 of FIG. 11 includes various blocks 1113, 1117, 1121, 1125, 1129, 1133 and 1137 that represent computer-readable storage medium (CRM) blocks or processor-readable medium blocks. Such blocks can include instructions that are computer-executable and/or processor-executable. A computer-readable storage medium is non-transitory, not a signal and not a carrier wave. A computer-readable storage medium is a physical component or components.

As an example, the system 250 of FIG. 2 or another system (e.g., computing system, etc.) may be utilized to implement at least a portion of one or more of the methods 800, 900, 1000 and 1100.

As an example, a method can include acquiring measurement values from at least two different types of downhole tools disposed in a portion of a bore in a formation; selecting formation parameters for joint inversion; building a near-bore fluid flow model of at least a portion of the formation that includes at least the portion of the bore; simulating fluid flow based at least in part on the near-bore fluid flow model and the selected formation parameters to generate simulated measurement values; comparing the acquired measurement values and the simulated measurement values; based at least in part on the comparing, revising at least one of the selected formation parameters to generate revised formation parameters and simulating fluid flow based at least in part on the near-bore fluid flow model and the revised formation parameters to generate revised simulated measurement values; and outputting at least the revised formation parameters where the revised formation parameters characterize the formation.

In the foregoing example, the selected formation parameters can be revised (e.g., adjusted) in an effort to achieve a match between the simulated measurement values and the acquired measurement values. Thus, the selected formation parameters may be selected in a manner whereby they have physics associated with the corresponding measurement values (e.g., with the physics associated with technologies of the at least two different types of downhole tools). For example, if adjustment of a formation parameter is likely to have little effect on a simulated measurement or simulated measurements, that formation parameter may optionally be a fixed value, which may be a value utilized for purposes of simulation but not necessarily for purposes of achieving convergence in an iterative manner between one or more simulated measurements and one or more acquired measurements.

As an example, formation parameters can include static and/or dynamic formation parameters. As an example, formation parameters can include least one member selected from a group of porosity, permeability, saturation, relative permeability and capillary pressure. One or more of such formation parameters may be selected for purposes of performing a joint inversion that aims to converge simulated measurement values with acquired measurement values where the simulated measurement values may be determined based at least in part on output of a fluid flow simulator (e.g., consider one or more of saturation, salinity and pressure as examples of output). As an example, one or more transforms may be utilized to “transform” a fluid flow simulator output value or values to one or more simulated measurement value or values.

As an example, a simulation may include determining mud-filtrate invasion. In such an example, a near-bore model may be utilized where the model accounts for a distance from a bore wall of a formation into the formation. In such an example, the near-bore model may be suitable for one or more staged of development of a formation such as a drilling stage, which may include LWD, and a wireline stage. As mentioned, phenomena such as mud-filtrate invasion, mud-cake formation, etc. may occur during one or more stages (e.g., as dynamic phenomena and/or static phenomena) that may affect one or more types of measurements. As an example, a method may account for error in a measurement via modeling of one or more phenomena (e.g., such as mud-filtrate invasion, etc.). Such an approach can provide for more accurate output of formation parameters (e.g., formation parameter values) even though a measurement may exhibit some type of error (e.g., a phenomenon related error, which may be an interpretation error as the extent of a type of phenomenon may be relatively unknown during interpretation).

As an example, a method can include simulating fluid flow based on a near-bore fluid model and revised formation parameters to generate simulated measurement values for a different portion of the bore in the formation.

As an example, at least two different types of downhole tools can include at least two members selected from a group of a sigma tool, a conductivity tool and a sonic tool.

As an example, at least two different types of downhole tools can include logging while drilling tools.

As an example, at least two different types of downhole tools can include wireline tools.

As an example, at least two different types of downhole tools can include at least one logging while drilling tool and at least one wireline tool.

As an example, simulating can include generating saturation, salinity and pressure values. Such simulating can be a numerical simulator based simulation that employs a reservoir simulator, which may be a finite-difference simulator or other type of simulator (e.g., finite element, finite volume, etc.). Such a simulator can discretize equations utilizing a grid or a mesh. As an example, a near-bore fluid flow model may be a discretized model according to a grid or a mesh where nodes, cells, elements, etc. are spaced and/or sized according to one or more types of physical phenomena associated with one or more types of measurements of a downhole tool or downhole tools as may be disposed in a bore defined by a formation. A near-bore fluid flow model may account for a bore space and a formation space that at least in part surrounds the bore space. Such a model may be vertical with respect to gravity, deviated or horizontal. Such a model may depend on the orientation of a portion of a bore in which one or more tools are disposed.

As an example, one or more simulated measurement values can be generated based at least in part on one or more of saturation, salinity and pressure values. As mentioned, one or more types of transforms may be utilized (see, e.g., block 870 of FIG. 8, block 970 of FIG. 9, etc.).

As an example, a method can include outputting at least one member selected from a group of the near-bore fluid flow model and a calibrated rock physics model.

As an example, a method can include drilling into a formation. In such an example, a method can include acquiring measurement values from at least two different types of downhole tools disposed in one or more portions of a bore in the formation. Such a method can include acquiring measurement values in one portion of the bore (e.g., one measured depth), moving the tools and acquiring additional measurement values in another portion of the bore (e.g., at another measured depth).

As an example, a method can include drilling into a formation based at least in part on a near-bore fluid flow model, revised formation parameters, or a near-bore fluid flow model and revised formation parameters.

As an example, a system can include a processor; memory operatively coupled to the processor; and processor-executable instructions stored in the memory to instruct the system to: acquire measurement values from at least two different types of downhole tools disposed in a portion of a bore in a formation; select formation parameters for joint inversion; build a near-bore fluid flow model of at least a portion of the formation that includes at least the portion of the bore; simulate fluid flow based at least in part on the near-bore fluid flow model and the selected formation parameters to generate simulated measurement values; compare the acquired measurement values and the simulated measurement values; based at least in part on the comparison, revise at least one of the selected formation parameters to generate revised formation parameters and simulating fluid flow based at least in part on the near-bore fluid flow model and the revised formation parameters to generate revised simulated measurement values; and output at least the revised formation parameters where the revised formation parameters characterize the formation. In such an example, the system can include processor-executable instructions stored in the memory to instruct the system to determine mud-filtrate invasion. As an example, the processor-executable instructions to simulate can account for mud-filtrate invasion.

As an example, one or more computer-readable storage media can include computer-executable instructions executable to instruct a computing system to: acquire measurement values from at least two different types of downhole tools disposed in a portion of a bore in a formation; select formation parameters for joint inversion; build a near-bore fluid flow model of at least a portion of the formation that includes at least the portion of the bore; simulate fluid flow based at least in part on the near-bore fluid flow model and the selected formation parameters to generate simulated measurement values; compare the acquired measurement values and the simulated measurement values; based at least in part on the comparison, revise at least one of the selected formation parameters to generate revised formation parameters and simulating fluid flow based at least in part on the near-bore fluid flow model and the revised formation parameters to generate revised simulated measurement values; and output at least the revised formation parameters where the revised formation parameters characterize the formation. In such an example, the computer-executable instructions to simulate can account for mud-filtrate invasion.

As an example, a workflow may be associated with various computer-readable medium (CRM) blocks. Such blocks generally include instructions suitable for execution by one or more processors (or cores) to instruct a computing device or system to perform one or more actions. As an example, a single medium may be configured with instructions to allow for, at least in part, performance of various actions of a workflow. As an example, a computer-readable medium (CRM) may be a computer-readable storage medium. As an example, blocks may be provided as one or more sets of instructions, for example, such as the one or more sets of instructions 270 of the system 250 of FIG. 2.

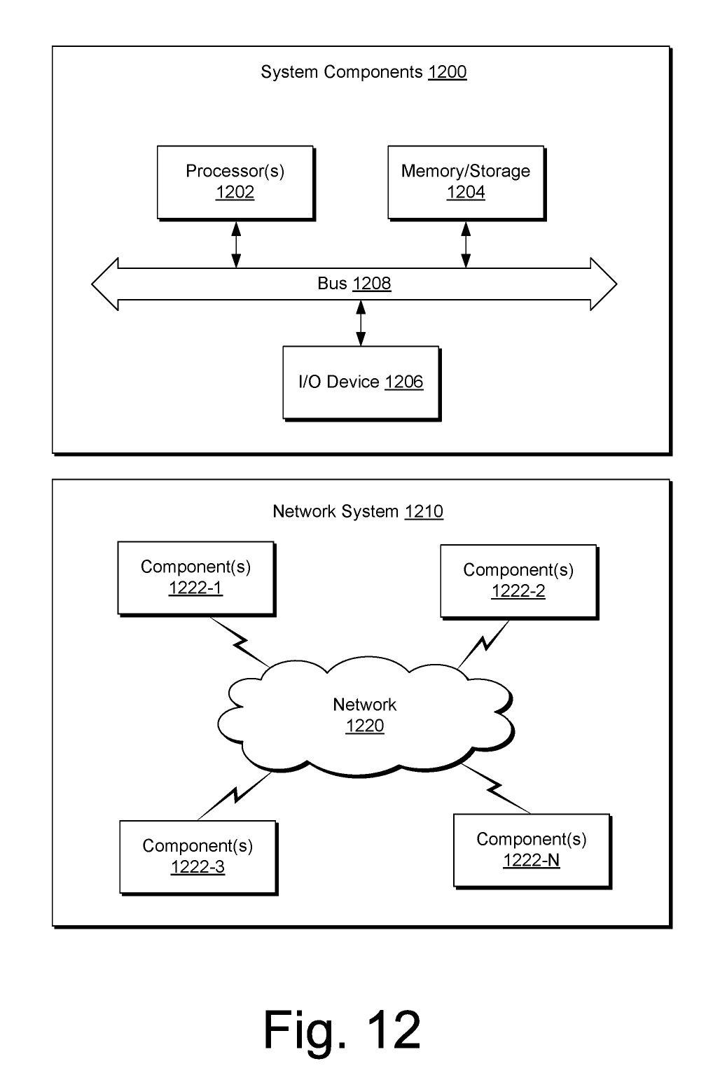

FIG. 12 shows components of an example of a computing system 1200 and an example of a networked system 1210. The system 1200 includes one or more processors 1202, memory and/or storage components 1204, one or more input and/or output devices 1206 and a bus 1208. In an example embodiment, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1210. The network system 1210 includes components 1222-1, 1222-2, 1222-3, . . . 1222-N. For example, the components 1222-1 may include the processor(s) 1202 while the component(s) 1222-3 may include memory accessible by the processor(s) 1202. Further, the component(s) 1202-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke means-plus-function clauses for any limitations of any of the claims herein, except for those in which the claim expressly uses the words “means for” together with an associated function.

### NOMENCLATURE

Σ: Sigma (formation capture cross section)

σ: Conductivity

Vp: P-wave velocity

Vs: S-wave velocity

ρ: Density

r: Spatial coordinate

t: Temporal coordinate

Kr: Relative permeability

Pc: Capillary pressure

### SOME DOCUMENTS INCORPORATED BY REFERENCE HEREIN

[1] G. Weller, R. Griffiths, C. Stoller, F. Allioli, M. Berheide, M. Evans, L. Labous, D. Dion, P. Perciot, “A new integrated LWD platform brings next-generation formation evaluation services”, SPWLA 46th Annual Logging Symposium, Jun. 26-29, 2005.
[2] Herron, S. L. and Herron, M. M., “Quantitative lithology: an application for open and cased hole spectroscopy”, SPWLA 37th Annual Logging Symposium, Jun. 16-19, 1996.
[3] S. Shetty, D. Omeragic, T. Habashy, J. Miles, J. Rasmus, R. Griffiths, and C. Morriss, “Inversion-based workflows for interpretation of nuclear density images in high-angle and horizontal wells”, SPWLA 53^{rd} Annual Logging Symposium, Jun. 16-20, 2012.
[4] A. Gyllensten, S. Al-Arfi, M. A. Hammadi, K. A. Marzouqi, A. Madjidi, M. Mauborgne, and G. Weller, “Advances in LWD sigma measurements and application to real-time formation evaluation in carbonate reservoirs”, SPWLA 50th Annual Logging Symposium, Jun. 21-24, 2009.
[5] Ramakrishnan, T. S., and D. J. Wilkinson, “Water-cut and fractional flow logs from array-induction measurements”, SPE Reservoir Evaluation & Engineering, 2, 85-94, 1999.
[6] Alpak, F. O., T. M. Habashy, C. Torres-Verdin, and V. Dussan, 2004a, Joint inversion of pressure and time-lapse electromagnetic logging measurements: Petrophysics, 45, 251-267.
[7] Liang, L., A. Abubakar, and T. M. Habashy, 2011, Estimating petrophysical parameters and average mud-filtrate invasion rates using joint inversion of induction logging and pressure transient data, Geophysics, VOL. 76, NO. 2, P. E21-E34.
[8] T. M. Habashy and A. Abubakar, A General Framework For Constraint Minimization For The Inversion Of Electromagnetic Measurements, Progress In Electromagnetics Research, PIER 46, 265-312, 2004.
[9] Bonner, S., Tabanou, J., Wu, P., Seydoux, J., Moriarty, K., Seal, B., Kowk, E., and Kuchenbecker, M., 1995, New 2-MHz multi-array borehole-compensated resistivity tool developed for MWD in slim holes, SPE 30547.
[10] Li, Q., C. Liu, C. Maeso, P. Wu, J. Smits, H. Prabawa, and J. Bradfield, 2004, Automated interpretation for LWD propagation resistivity tools through integrated model selection, Petrophysics, VOL. 45, No. 1, P. 14-26.
[11] Mauro Da Cruz, Edwin Vervest, and Hendrayadi Prabawa, 2013, Single-run “mega-combo” LWD/MWD improves formation evaluation offshore Angola, World Oil, May 2013.
[12] A. Valdisturlo, M. Mele, D. Maggs, S. Lattuada, and R. Griffiths, 2013, Improved petrophysical analysis in horizontal wells: from log modeling through formation evaluation to reducing model uncertainty—a case study, SPE 164881.
[13] K. Sun, C. Morriss, K. Ito, S. Asif, J. Rasmus, R. Griffiths, D. Maggs, D. Omeragic, S. Crary, A. Abubakar, Automated Resistivity Inversion for Efficient Formation Evaluation in High-Angle and Horizontal Wells, presented at the 55th SPWLA Annual Symposium, Abu Dhabi, UAE, 18-22 May 2014.
[14] Y. Lin, A. Abubakar, T. M. Habashy, G. Pan, M. Li, V. Druskin, and L. Knizhnerman, Schemes for improving efficiency of pixel-based inversion algorithms for electromagnetic logging while drilling measurements, SEG Expanded Abstracts 31, 4p, 2012.
[15] Schroeder, T., 2001, Grappling with LWD resistivity logs: What is Rₜ and Rₓₒ? Paper KK, in 42^{nd} Annual Logging Symposium Transactions: SPWLA.
[16] Olabode Ijasan, Carlos Torres-Verdin, and William E. Preeg, 2013, Inversion-based petrophysical interpretation of logging-while-drilling nuclear and resistivity measurements, Geophysics, VOL. 78, NO. 6, P. D473-D489.
[17] A. Abubakar, T. M. Habashy, V. Druskin, L. Knizhnerman and D. Alumbaugh, Two-and-half dimensional forward and inverse modelling for the interpretation of low-frequency electromagnetic measurements, Geophysics, Vol. 73, No. 4, F165-F177, July-August 2008.
[18] A. Abubakar, T. M. Habashy, V. Druskin, S. Davydycheva, and L. Knizhnerman, A three-dimensional parametric inversion algorithm for triaxial induction logging data, Geophysics, Vol. 71, No. 1, January 2006.
[19] M. Li, A. Abubakar, T. Habashy and Y. Zhang, Inversion of CSEM Data with Model-Based Inversion Algorithm, Geophysical Prospecting, Vol. 58, Issue 3, May 2010, pp. 455-467.

What is claimed is:

1. A method comprising:
acquiring measurement values from at least two different types of downhole tools disposed in a portion of a bore in a formation;
selecting formation parameters for joint inversion;
building a near-bore fluid flow model of at least a portion of the formation that comprises at least the portion of the bore;
simulating fluid flow based at least in part on the near-bore fluid flow model and the selected formation parameters to generate simulated measurement values;
comparing the acquired measurement values and the simulated measurement values;
based at least in part on the comparing, revising at least one of the selected formation parameters to generate revised formation parameters and simulating fluid flow based at least in part on the near-bore fluid flow model and the revised formation parameters to generate revised simulated measurement values; and
outputting at least the revised formation parameters wherein the revised formation parameters characterize the formation.

2. The method of claim 1 wherein the formation parameters comprise static and dynamic formation parameters.

3. The method of claim 1 wherein the formation parameters comprise at least one member selected from a group consisting of porosity, permeability, saturation, relative permeability and capillary pressure.

4. The method of claim 1 wherein the simulating determines mud-filtrate invasion.

5. The method of claim 1 comprising simulating fluid flow based on the near-bore fluid flow model and the revised formation parameters to generate simulated measurement values for a different portion of the bore in the formation.

6. The method of claim 1 wherein the at least two different types of downhole tools comprise at least two members selected from a group consisting of a sigma tool, a conductivity tool and a sonic tool.

7. The method of claim 1 wherein the at least two different types of downhole tools comprise logging while drilling tools.

8. The method of claim 1 wherein the at least two different types of downhole tools comprise wireline tools.

9. The method of claim 1 wherein the at least two different types of downhole tools comprise at least one logging while drilling tool and at least one wireline tool.

10. The method of claim 1 wherein the simulating comprises generating saturation, salinity and pressure values.

11. The method of claim 10 wherein the simulated measurement values are generated based at least in part on one or more of the saturation, salinity and pressure values.

12. The method of claim 1 comprising outputting at least one member selected from a group consisting of the near-bore fluid flow model and a calibrated rock physics model.

13. The method of claim 1 comprising acquiring additional measurement values from the at least two different types of downhole tools disposed in a different portion of the bore in the formation.

14. The method of claim 1 comprising drilling into the formation.

15. The method of claim 1 comprising drilling into the formation based at least in part on the near-bore fluid flow model, the revised formation parameters, or the near-bore fluid flow model and the revised formation parameters.

16. A system comprising:
a processor;
memory operatively coupled to the processor; and
processor-executable instructions stored in the memory to instruct the system to:
acquire measurement values from at least two different types of downhole tools disposed in a portion of a bore in a formation;
select formation parameters for joint inversion;
build a near-bore fluid flow model of at least a portion of the formation that includes at least the portion of the bore;
simulate fluid flow based at least in part on the near-bore fluid flow model and the selected formation parameters to generate simulated measurement values;
compare the acquired measurement values and the simulated measurement values;
based at least in part on the comparison, revise at least one of the selected formation parameters to generate revised formation parameters and simulating fluid flow based at least in part on the near-bore fluid flow model and the revised formation parameters to generate revised simulated measurement values; and
output at least the revised formation parameters wherein the revised formation parameters characterize the formation.

17. The system of claim 16 comprising processor-executable instructions stored in the memory to instruct the system to determine mud-filtrate invasion.

18. The system of claim 16 wherein the processor-executable instructions to simulate account for mud-filtrate invasion.

19. One or more computer-readable storage media comprising computer-executable instructions executable to instruct a computing system to:
acquire measurement values from at least two different types of downhole tools disposed in a portion of a bore in a formation;
select formation parameters for joint inversion;
build a near-bore fluid flow model of at least a portion of the formation that includes at least the portion of the bore;
simulate fluid flow based at least in part on the near-bore fluid flow model and the selected formation parameters to generate simulated measurement values;
compare the acquired measurement values and the simulated measurement values;
based at least in part on the comparison, revise at least one of the selected formation parameters to generate revised formation parameters and simulating fluid flow based at least in part on the near-bore fluid flow model and the revised formation parameters to generate revised simulated measurement values; and
output at least the revised formation parameters wherein the revised formation parameters characterize the formation.

20. The one or more computer-readable storage media of claim 19 wherein the computer-executable instructions to simulate account for mud-filtrate invasion.
